(19) United States
(12) Patent Application Publication
(10) Pub. No.: US 2012/0107478 A1
(43) Pub. Date: May 3, 2012

(54) Omega-3 Fatty Acid Enriched Baked Foods and Bar Composition

(75) Inventors: Seok Lee, Edwardsville, IL (US); David Welsby, University City, MO (US); Beata E. Lambach, St. Louis, MO (US); Jennifer White, St. Louis, MO (US)

(73) Assignee: Solae, LLC, St. Louis, MO (US)

(21) Appl. No.: 13/381,415

(22) PCT Filed: Jun. 29, 2010
(86) PCT No.: PCT/US10/40462

§ 371 Date: Dec. 29, 2011

Related U.S. Application Data
(60) Provisional application No. 61/221,949, filed on Jun. 30, 2009.

(51) Int. Cl. A21D 2/08; A23D 7/00; C11B 5/00; A23J 1/14; A23D 9/00; A23J 1/20

(52) U.S. Cl. 426/541; 426/601; 426/585; 426/549

(57) ABSTRACT

The present invention relates to compositions and methods for producing baked food compositions and bar compositions with a quantity of long chain fatty acids. Specifically, the baked food compositions and bar compositions comprise a quantity of stearidonic acid (SDA) enriched soybean oil that imparts improved nutritional quality with an amount of long chain fatty acids, but retains the mouthfeel, flavor, odor, and other sensory characteristics associated with typical baked food compositions and bar compositions.

### FIELD OF THE INVENTION

The present invention generally relates to baked foods and bar compositions with a quantity of polyunsaturated fatty acids and the method of making such compositions. More specifically, the invention is to baked food compositions and bar compositions that comprise a quantity of stearidonic acid (SDA) enriched soybean oil and methods of making the compositions. The baked food compositions and bar compositions possess improved nutritional qualities through the use of SDA enriched soybean oil to produce baked food compositions and bar compositions with a quantity of omega-3 polyunsaturated fatty acids (n-3 PUFAs).

### BACKGROUND OF THE INVENTION

Recent dietary studies have suggested that certain types of fats are beneficial to body functions and improved health. The use of dietary fats is associated with a variety of therapeutic and preventative health benefits. Current research has demonstrated that the consumption of foods rich in n-3 PUFAs and especially omega-3 long chain polyunsaturated fatty acids (n-3 LCPUFAs), such as eicosapentaenoic acid (EPA; 20:5, n-3) and docosahexaenoic acid (DHA; 22:6, n-3) decreases cardiovascular death by positively impacting a number of markers, such as decreasing plasma triglycerides and blood pressure, and reducing platelet aggregation and inflammation. Typically, n-3 PUFAs, including n-3 LCPUFAs are derived from plant or marine sources. Marine oils, found in fatty fish, are an important dietary source of the n-3 PUFAs, such as EPA and DHA. While fatty fish may be the best source of these omega-3 acids, many individuals do not like the taste of such seafood, do not have ready access to such seafood, or cannot afford such seafood. One solution is to supplement the diet with cod liver oil or fish oil capsules, but many people find the large capsules (ca. 1 g each) difficult to consume, and so this solution has limited compliance. Another solution is to add n-3 PUFAs rich fish oils directly to foods, cereal products, baked foods, and bar compositions.

A challenge with the latter approach is to provide the benefits of n-3 PUFAs without imparting any offending fish flavors or fish odors, which develop as a consequence of lipid oxidation. Currently, baked food compositions and bar compositions may be found in the marketplace that include a quantity of n-3 PUFAs derived from flax, used either as full-fat flour or as oil, both providing α-linolenic acid (ALA; 18:3 n-3), marine-based sources, such as fish oil, or from land-based algal sources produced by fermentation, typically DHA in this case. These ingredients contribute a significant quantity of n-3 PUFAs, but these sources of n-3 PUFAs produce unpleasant off flavors (flax oil), or are typically unstable and are especially susceptible to rapid oxidation. Consequently, in current products containing n-3 PUFAs from these sources, the levels of inclusion are very low and generally insufficient to have the desired health impact found at higher dietary levels of use. Because of the generally high temperature and other extreme processing conditions the baked food compositions and bar compositions must endure, the unstable n-3 PUFAs found in the marine or algal-derived sources produce highly undesirable fishy or painty off-flavors and odors when developing/processing/storing the baked food compositions and bar compositions. Therefore, there is a need for baked food compositions and bar compositions that include a physiologically significant quantity of n-3 PUFAs, that when included with baked food compositions and bar compositions that are then prepared and baked normally and do not produce fishy or other unacceptable flavors or odors in the final products.

Additionally, it is possible to consume certain plant derived food products or supplements that contain n-3 PUFAs. These plant derived n-3 PUFAs often consist of α-linolenic acid (ALA; 18:3, n-3). ALA is susceptible to oxidation which results in painty off-odors. Moreover, the bioconversion of ALA to n-3 LCPUFAs (specifically EPA) is relatively inefficient. Thus, there is a need for forms of n-3 PUFAs that provide the benefits of ready conversion to n-3 LCPUFAs, as well as good oxidative stability in foods. Additionally, there is a need for a process that includes a quantity of stable n-3 PUFAs that are readily metabolized to n-3 LCPUFAs and the resultant baked food compositions and bar compositions. As previously stated, the plant derived n-3 PUFAs (ALA) are also susceptible to oxidization and can impart offensive painty odors and tastes when exposed to extreme processing steps and the processing environment. Therefore, there is a need for processes and resultant baked food compositions and bar compositions, such as cereal-based baked foods, granola bars, sheet and cut bars, and extruded bars that include a quantity of n-3 PUFAs, are stable and do not impart fishy or painty odors or tastes due to oxidation of the n-3-PUFAs during the processing steps, while being transported, and/or stored before consumption.

### SUMMARY OF THE INVENTION

The present invention is to baked food compositions and bar compositions that include a quantity of SDA enriched soybean oil. The SDA enriched soybean oil contains n-3 PUFAs that when incorporated into baked food compositions and bar compositions, provides a clean flavor, longer shelf life stability, minimal oxidation, stability when exposed to extreme processing conditions, and enhanced nutritional qualities when compared to other sources of n-3 PUFAs. Further, the baked food compositions and bar compositions with the SDA enriched soybean oil possess similar taste, mouthfeel, odor, flavor, and sensory characteristics when compared to products made from conventional oils, such as soybean oil, but with increased nutritional values.

Additionally, the baked food compositions and bar compositions may include an amount of a stabilizing agent such as lecithin. Other stabilizing agents, such as other phospholipids or antioxidants, can be combined with the SDA enriched soybean oil for incorporation into the baked food compositions and bar compositions. The incorporation of the stabilizing agents produces baked food compositions and bar compositions that possess similar taste, mouthfeel, odor, flavor, and sensory characteristics when compared to products made from conventional oils, such as soybean oil, but with increased nutritional values, and further has enhanced storage and shelf stability.

Further, the baked food compositions and bar compositions may include a quantity of protein such as soy protein, pea protein, milk protein, and combinations thereof. While these specific proteins are mentioned any protein that is known in the art for use in baked food compositions and bar compositions can be used.

The present invention is also directed to a method of using SDA enriched soybean oil and a stabilizing agent to produce baked food compositions and bar compositions that have enhanced nutritional qualities but similar taste, mouthfeel, odor, flavor, and sensory properties when compared to typical baked food compositions and bar compositions.

The current invention demonstrates processes, compositions, end products, and methods of using SDA enriched soybean oil for baked food compositions and bar compositions that possess certain nutritional and beneficial qualities for a consumer and have enhanced storage and shelf stability. But the baked food compositions and bar compositions also have similar taste, mouthfeel, odor, and flavor as that formed in typical baked food compositions and bar compositions desired by consumers.

### DESCRIPTION OF THE FIGURES

FIG. 1 graphically illustrates the sensory profiling of apple cinnamon baked bars flavor differences based on Soybean Oil and SDA Oil at Time 0. The black dashed line marks the Recognition Threshold Level.

FIG. 2 illustrates the sensory profiling of apple cinnamon baked bars texture differences based on Soybean Oil and SDA Oil at Time 0.

FIG. 3 graphically illustrates the sensory profiling of apple cinnamon baked bars flavor differences based on Soybean Oil and SDA Oil at 6 Months. The black dashed line marks the Recognition Threshold Level.

FIG. 4 illustrates the sensory profiling of apple cinnamon baked bars texture differences based on Soybean Oil and SDA Oil at 6 Months.

FIG. 5 summarizes consumer acceptance ratings for apple cinnamon baked bars at 3 Months stored at 25° C. prepared with Soybean Oil and SDA Oil.

FIG. 6 summarizes consumer acceptance ratings for apple cinnamon baked bars at 3 Months stored at 37° C. prepared with Soybean Oil and SDA Oil.

FIG. 7 summarizes consumer acceptance ratings for apple cinnamon baked bars at 6 Months stored at 25° C. prepared with Soybean Oil and SDA Oil.

FIG. 8 graphically illustrates the sensory profiling of plain bagels flavor differences based on Soybean Oil and SDA Oil at 6 Months. The black dashed line marks the Recognition Threshold Level.

FIG. 9 illustrates the sensory profiling of plain bagels texture differences based on Soybean Oil and SDA Oil at 6 Months.

FIG. 10 summarizes consumer acceptance ratings for plain bagels prepared with Soybean Oil and SDA Oil.

### DETAILED DESCRIPTION OF THE INVENTION

The present invention relates to a method of using SDA enriched soybean oil, processes for producing baked food compositions and bar compositions, and the resultant baked food compositions and bar compositions that have an increased nutritional value for consumers to improve their health. Further, the invention is to baked food compositions and bar compositions with increased nutritional values that include a quantity of n-3 PUFA but retain the mouthfeel, flavor, odor, and other sensory characteristics of typical baked food compositions and bar compositions that consumers desire.

Use of n-3 PUFAs and especially n-3 LC-PUFAs in baked food compositions and bar compositions is typically limited by their lack of oxidative stability. Because of the harsh processing conditions for baked food compositions and bar compositions (elevated temperatures, often in forced convection ovens), n-3 PUFAs are readily oxidized and produce off flavors in the finished baked food compositions and bar compositions. By using a type of n-3 PUFAs that is oxidatively stable during mixing, processing, and packaging phases and during storage, transport, and shelf life baked food compositions and bar compositions are produced that not only retain the mouthfeel, flavor, odor, and other sensory characteristics typical baked food compositions and bar compositions posses but also has increased nutritional value.

### (I) Compositions

One aspect of the present invention is baked food compositions and bar compositions that comprise an amount of n-3 PUFAs. The n-3 PUFAs are incorporated into the baked food compositions and bar compositions through the use of SDA enriched soybean oil. In one embodiment the SDA enriched soybean oil is obtained from soybeans that are engineered to produce high levels of SDA, such as those described in WO2008/085840 and WO2008/085841. The soybeans can be processed according to the extraction method consistent with those methods described in US Patent Application 2006/0111578 and 2006/0111254. In another embodiment, oil obtained from other plant sources with elevated SDA, such as but not limited to Echium spp. and blackcurrant oil can be used.

In another embodiment soy flour can be used that is enriched with SDA, either from SDA enriched soybeans or through other processes known in the industry. The SDA enriched soy flour is produced according to typical processes known in the industry, with the SDA enriched soy flour used to replace current soy flour or other baking flours and ingredients during the production of the baked food compositions and bar compositions. The resultant products are baked food compositions and bar compositions with the desired nutritional characteristics that retain the mouthfeel, flavor, odor, and other sensory characteristics of typical baked food compositions and bar compositions.

In another embodiment, the baked food compositions and bar compositions may further include a phospholipid to stabilize the oxidizable material and thus reduce its oxidation. A phospholipid comprises a backbone, a negatively charged phosphate group attached to an alcohol, and at least one fatty acid. Phospholipids having a glycerol backbone comprise two fatty acids and are termed glycerophospholipids. Examples of a glycerophospholipid include phosphatidylcholine, phosphatidylethanolamine, phosphatidylinositol, phosphatidylserine, and diphosphatidylglycerol (i.e., cardiolipin). Phospholipids having a sphingosine backbone are called sphingomyelins. The fatty acids attached via ester bonds to the backbone of a phospholipid tend to be 12 to 22 carbons in length, and some may be unsaturated. For example, phospholipids may contain oleic acid (18:1), linolenic acid (18:2, n-6), and alpha-linolenic acid (18:3, n-3). The two fatty acids of a phospholipid may be the same or they may be different; e.g., dipalmitoylphosphatidylcholine, 1-stearyoyl-2-myristoylphosphatidylcholine, or 1-palmitoyl-2-linoleoylethanolamine.

In one embodiment, the phospholipid may be a single purified phospholipid, such as distearoylphosphatidylcholine. In another embodiment, the phospholipid may be mixture of purified phospholipids, such as a mix of phosphatidylcholines. In still another embodiment, the phospholipid may be a mixture of different types of purified phospholipids, such as a mix of phosphatidylcholines and phosphatidylinositols or a mixture of phosphatidylcholines and phosphatidylethanolamines.

In an alternative embodiment, the phospholipid may be a complex mix of phospholipids, such as a lecithin. Lecithin is found in nearly every living organism. Commercial sources of lecithin include soybeans, rice, sunflower seeds, chicken egg yolks, milk fat, bovine brain, bovine heart, and algae. In its crude form, lecithin is a complex mixture of phospholipids, glycolipids, triglycerides, sterols and small quantities of fatty acids, carbohydrates and sphingolipids. Soy lecithin is rich in phosphatidylcholine, phosphatidylethanolamine, phosphatidylinositol, and phosphatidic acid. Lecithin may be de-oiled and treated such that it is an essentially pure mixture of phospholipids. Lecithin may be modified to make the phospholipids more water-soluble. Modifications include hydroxylation, acetylation, and enzyme treatment, in which one of the fatty acids is removed by a phospholipase enzyme and replaced with a hydroxyl group. In another embodiment the lecithin could be produced as a byproduct of the oil production from the SDA enriched soybeans, thus producing a product with a portion of the lecithin to be used with the SDA enriched soybean oil.

In yet another alternative embodiment, the phospholipid may be a soy lecithin produced under the trade name SOLEC® by Solae, LLC (St. Louis, Mo.). The soy lecithin may be SOLEC®F in a dry, de-oiled, non-enzyme modified preparation containing about 97% phospholipids. The soy lecithin may be SOLEC® 8160, a dry, de-oiled, enzyme modified preparation containing about 97% phospholipids. The soy lecithin may be SOLEC® 8120, a dry, de-oiled, hydroxylated preparation containing about 97% phospholipids. The soy lecithin may be SOLEC® 8140, a dry, de-oiled, heat resistant preparation containing about 97% phospholipids. The soy lecithin may be SOLEC®R, a dry, de-oiled preparation in granular form containing about 97% phospholipids.

The ratio of the phospholipid to the SDA enriched soybean oil will vary depending upon the nature of the SDA enriched soybean oil and the phospholipid preparation. In particular, the concentration of phospholipid will be of a sufficient amount to prevent the oxidation of the SDA enriched soybean oil. The concentration of the phospholipid will generally range from less than 0.1% to about 65% by weight of the SDA enriched soybean oil. In one embodiment, the concentration of the phospholipid may range from about 2% to about 50% by weight of the SDA enriched soybean oil. In another embodiment, the concentration of the phospholipid may range from about 2% to about 10% by weight of the SDA enriched soybean oil. In an alternative embodiment, the concentration of the phospholipid may range from about 10% to about 20% by weight of the SDA enriched soybean oil. In yet another embodiment, the concentration of the phospholipid may range from about 20% to about 30% by weight of the oxidizable material. In still another embodiment, the concentration of the phospholipid may range from about 30% to about 40% by weight of the SDA enriched soybean oil. In another alternative embodiment, the concentration of the phospholipid may range from about 40% to about 50% by weight of the SDA enriched soybean oil. In another embodiment, the concentration of the phospholipid may range from about 15% to about 35% by weight of the SDA enriched soybean oil. In another embodiment, the concentration of the phospholipid may range from about 25% to about 30% by weight of the SDA enriched soybean oil.

The baked food compositions and bar compositions may comprise at least one additional antioxidant that is not a phospholipid or a lecithin. The additional antioxidant may further stabilize the SDA enriched soybean oil. The antioxidant may be natural or synthetic. Suitable antioxidants include, but are not limited to, ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., lonox 100), 2,4-(tris-3′,5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof. Preferred antioxidants include tocopherols, ascorbyl palmitate, ascorbic acid, and rosemary extract. The concentration of the additional antioxidant or combination of antioxidants may range from about 0.001% to about 5% by weight, and preferably from about 0.01% to about 1% by weight.

The baked food compositions and bar compositions may include a quantity of protein such as soy protein, pea protein, milk protein, and combinations thereof. While these specific proteins are mentioned any protein that is known in the art for use in baked food compositions and bar compositions can be used.

### (II) Method of Using and Processes for Forming the Compositions

Production of the n-3 PUFAs enriched baked food compositions and bar compositions is accomplished by replacing an amount of typical soybean oil used in baked food applications and bar applications with the SDA enriched soybean oil. In another embodiment, SDA enriched soybean oil can either replace part of or all of the existing fats in an application or can be added additionally to those products that are naturally, or formulated to be low in fat. In one embodiment, the SDA enriched soybean oil will replace all the fat and/or soybean oil used to produce the desired baked food compositions and bar compositions. In an alternative embodiment, the SDA enriched soybean oil will replace an amount of the fat and/or soybean oil used in the baked food compositions and bar compositions to produce end products that contain a sufficient amount of n-3 PUFAs as recommended by the industry. The general consensus in the omega-3 research community is for a consumer to consume around 400-500 mg/day of EPA/DHA equivalent. (Harris et al. J. Nutr. (2009) 139:804S-819S). Typically a consumer will consume four (4) 100 mg/servings per day to ultimately consume 400 mg/day.

The baked food compositions and bar compositions are generally formed dependent on the desired end product. The baked food compositions and bar compositions are produced according to standard industry recipes except the fat and/or oil ingredient typically used is partially or totally replaced with the SDA enriched soybean oil. The amount of SDA enriched soybean oil used will vary from 1% to 100% of the original amount of fat and/or oil included in the formula and is dependent on the end product and the nutritional value or amount of n-3 PUFAs desired in the end product. In one embodiment, 5% of the fat and/or oil used in typical baked food compositions and bar compositions is replaced with the SDA enriched soybean oil. In another embodiment, 10% of the fat and/or oil used in typical baked food compositions and bar compositions is replaced with the SDA enriched soybean oil. In another embodiment, 25% of the fat and/or oil used in typical baked food compositions and bar compositions is replaced with the SDA enriched soybean oil. In another embodiment, 50% of the fat and/or oil used in typical baked food compositions and bar compositions is replaced with the SDA enriched soybean oil. In another embodiment, 75% of the fat and/or oil used in typical baked food compositions and bar compositions is replaced with the SDA enriched soybean oil. In another embodiment, 90% of the fat and/or oil used in typical baked food compositions and bar compositions is replaced with the SDA enriched soybean oil. In another embodiment, 95% of the fat and/or oil used in typical baked food compositions and bar compositions is replaced with the SDA enriched soybean oil. In another embodiment, 100% of the fat and/or oil used in typical baked food compositions and bar compositions is replaced with the SDA enriched soybean oil.

In another embodiment, an amount of a stabilizing agent, such as a phospholipid, is added to the baked food composition dough and/or bar composition dough. In one embodiment, the phospholipid is a lecithin and is combined with the SDA enriched soybean oil, the concentration of the lecithin in the baked food compositions and bar compositions is from less than 0.1% to about 65% by weight of the SDA enriched soybean oil, and more typically, from about 15% to about 35% by weight of the SDA enriched soybean oil. In another embodiment, the concentration of the lecithin in the baked food compositions and bar compositions is from about 25% to about 30% by weight of the SDA enriched soybean oil. In another embodiment an amount of SDA enriched soybean oil can be added in addition to the fat or oil typically used in the baked food compositions and bar compositions.

In a further embodiment a quantity of protein is added to the baked food compositions and bar compositions. The protein can be any protein known to work in baked food compositions and bar compositions including but not limited to soy protein, pea protein, milk protein, and combinations thereof. Soy proteins that can be incorporated into the baked food compositions and bar compositions include soy protein isolate, soy protein concentrate, soy flour, and combinations thereof.

### (III) Food Products

A further aspect of the present invention are baked food and bar compositions and bar compositions with n-3 PUFAs incorporated and increased nutritional values, which retain the mouthfeel, flavor, odor, and other sensory characteristics of typical baked food and bar compositions. The baked food and bar compositions will vary depending on the desired end product but can include and are not limited to cereal-based products, sheet and cut bars, extruded bars, and baked bars. Non-limiting examples of baked food and bar compositions include breakfast cereals, breads, cakes, pies, rolls, cookies, crackers, tortillas, pastries, frozen doughs, par baked doughs, granola bars (baked or extruded), nutrition bars, and energy bars.

### DEFINITIONS

To facilitate understanding of the invention several terms are defined below.

The term “N-3 PUFAs” refers to omega-3 polyunsaturated fatty acids and includes omega-3 long chain polyunsaturated fatty acids and n-3 LCPUFAs.

The term “milk” refers to animal milk, plant milk, and nut milk. Animal milk is a white fluid secreted by the mammary glands of female mammals consisting of minute globules of fat suspended in a solution of casein, albumin, milk sugar, and inorganic salts. Animal milk includes but is not limited to milk from cows, goats, sheep, donkeys, camels, camelids, yaks, water buffalos. Plant milk is a juice or sap found in certain plants and includes but is not limited to milk derived from soy, and other vegetables. Nut milk is an emulsion made by bruising seeds and mixing with a liquid, typically water. Nuts that can be used for milk include but are not limited to almonds and cashews.

The term “milk protein” refers to any protein contained in milk as defined above, including any fractions extracted from the milk by any means known in the art. Milk protein further includes any combinations of milk proteins.

The terms “stearidonic acid enriched soybean oil”, “SDA enriched soybean oil”, and “SDA oil” refer to soybean oil that has been enriched with stearidonic acid.

The following examples are included to demonstrate preferred embodiments of the invention. It should be appreciated by those of skill in the art that the techniques disclosed in the examples that follow represent techniques discovered by the inventors to function well in the practice of the invention. However, those of skill in the art should, in light of the present disclosure, appreciate that many changes can be made in the specific embodiments that are disclosed and still obtain a like or similar result without departing from the spirit and scope of the invention, therefore all matter set forth or shown in the application is to be interpreted as illustrative and not in a limiting sense.

### EXAMPLES

### Example 1

### Wheat Bread

The following example relates to a method for making a wheat bread composition that contains a quantity of SDA enriched soybean oil.

Wheat bread was made according to typical industry processing techniques using the “Sponge and Dough” method following the step-by-step process below. Table 1 is the list of ingredients and the amount used in grams.

TABLE 1

| | | Soybean | | |
|---|---|---|---|---|
| | Soybean | Oil | | |
| | Oil | Control | SDA | SDA-Oil |
| Ingredients | Control % | (g) | Oil % | (g) |
| Sponge | | | | |
| Whole Wheat Flour, | 33.67 | 700.00 | 33.67 | 700.00 |
| Ultra fine | | | | |
| Instant Dry Yeast | 0.58 | 12.00 | 0.58 | 12.00 |
| Vital Wheat Gluten | 2.41 | 50.00 | 2.41 | 50.00 |
| Water (<4° C.), (<40° F.) | 24.29 | 505.00 | 24.29 | 505.00 |
| Mineral Yeast Food | 0.24 | 5.00 | 0.24 | 5.00 |
| (Non-Brominated Type) | | | | |
| Grindsted SSLP55 Veg | 0.24 | 5.00 | 0.24 | 5.00 |
| Sponge Total | 61.42 | 1277.00 | 61.42 | 1277.00 |
| Dough | | | | |
| Whole White Flour, | 14.43 | 300.00 | 14.43 | 300.00 |
| Ultra Fine | | | | |
| Salt | 0.96 | 20.00 | 0.96 | 20.00 |
| Honey 6%, = 4.944% sugar | 2.89 | 60.00 | 2.89 | 60.00 |
| Brown Sugar | 0.96 | 20.00 | 0.96 | 20.00 |
| Yeast, compressed | 0.48 | 10.00 | 0.48 | 10.00 |
| High Fructose Corn Syrup | 1.92 | 40.00 | 1.92 | 40.00 |
| (HFCS)-42 4%, = 2.84% | | | | |
| sugar | | | | |
| Calcium propionate | 0.12 | 2.50 | 0.12 | 2.50 |
| Monoglyceride | 0.24 | 5.00 | 0.24 | 5.00 |
| Bake Soft C 1650 | 0.02 | 0.31 | 0.02 | 0.31 |
| Ascorbic Acid 60 ppm | 5.29 | 11.00 | 5.29 | 11.00 |
| Lecithin | 0.48 | 10.00 | 0.48 | 10.00 |
| Commercial Soybean Oil | 3.28 | 68.20 | 3.28 | 0.00 |
| SDA enriched Soybean Oil | 0.00 | 0.00 | 0.00 | 68.20 |
| Water | 7.50 | 156.00 | 7.50 | 156.00 |
| Total Dough Weight | 38.58 | 703.01 | 38.58 | 703.01 |
| Total of dough and sponge | 100.00 | 1980.01 | 100.00 | 1980.01 |

The ingredients were combined and processed according to the following steps to produce the wheat bread composition:

I. Production of Sponge
A. The Sponge ingredients were combined and mixed for 1 minute on medium and 3 minutes on speed 2 using a Hobart A-200 mixer with McDuffie attachment;
B. During the combining of the Sponge ingredients the temperature was maintained at 26° C.;
C. The sponge was then allowed to ferment for 2.5 to 3 hours at 35° C. and 85% relative humidity (RH);

II. Production of Dough
A. The dough ingredients were combined in a mixing bowl, and mixed at speed 1 for 1 minute, next the sponge mixture was added and mixed for 4 minutes on speed 2;
B. The dough mixture was allowed to rest for 10 minutes;
C. The dough was separated into 570 g round pieces;
D. The dough pieces were placed on a sheet and molded;
E. Dough pieces were proofed for 60 minutes at 43° C. and 90% RH;
F. Finally the dough pieces were baked in a preheated oven at 221° C. for 22 minutes.

The results were a wheat bread composition that has an increased amount of n-3 PUFAs, but retains the taste, structure, aroma, and mouthfeel of typical wheat bread products currently on the market.

Fatty acid analysis was conducted on quadruplicate bread samples and SDA calculated as triglycerides using the Official Methods and Recommended Practices of the AOCS, Official methods Ce 1-62 (1997), Ce 2-66, Ce 1d-91, Ce 1k-07 (2007), and Ce 1i-07 (2007). The bread delivered 375 mg SDA per 50 g serving size against the target of 375 mg SDA per serving.

### Example 2

### Cracker

The following example relates to a method for making a cracker that contains a quantity of SDA enriched soybean oil.

The crackers were made according to the following process. Table 2 is the list of ingredients by weight in kilograms.

TABLE 2

| | | Soybean | SDA | SDA- |
|---|---|---|---|---|
| | Soybean | Oil | Enriched | enriched |
| | Oil | Control | Soybean | soybean |
| Ingredients | Control % | (g) | Oil % | oil (g) |
| Flour pastry (soft wheat) | 60.49 | 1209.80 | 60.49 | 1209.80 |
| flour | | | | |
| Commercial Soybean Oil | 11.85 | 237.05 | 0.00 | 0.00 |
| SDA enriched soybean | 0 | 0.00 | 11.85 | 237.05 |
| oil | | | | |
| Granulated sugar | 4.83 | 96.60 | 4.83 | 96.60 |
| HFCS (55%) | 3.63 | 72.60 | 3.63 | 72.60 |
| Non-Fat Dried Milk | 0.31 | 6.20 | 0.31 | 6.20 |
| (NFDM) | | | | |
| Lecithin | 0.12 | 2.40 | 0.12 | 2.40 |
| Salt | 0.60 | 12.00 | 0.60 | 12.00 |
| Sodium Bicarbonate | 0.53 | 10.60 | 0.53 | 10.60 |
| Monocalcium Phosphate | 0.56 | 11.20 | 0.56 | 11.20 |
| Water (32° C.) (90° F.) | 13.89 | 277.71 | 13.89 | 277.71 |
| Ammonium bicarbonate | 0.91 | 18.23 | 0.91 | 18.23 |
| Enzyme (crackerase) | 0.01 | 0.12 | 0.01 | 0.12 |
| Butter flavor | 0.18 | 3.60 | 0.18 | 3.60 |
| Total | 100.00 | 2000.00 | 100.00 | 2000.00 |

The ingredients were combined and processed according to the following steps to produce the crackers:
A. All dry ingredients were combined and blended for 5 minutes;
B. The remaining ingredients were added to the dry ingredient mixture (ammonium bicarbonate and enzyme should be predissolved in water and held back) including the ammonium bicarbonate mixture;
C. The mixture is mixed for an extended period of time, 10 to 15 minutes;
D. The dough is allowed to set and relax for 30 minutes at room temperature;
E. After the dough has set, it is divided into 75 gram pieces and rounded slightly by hand;
F. The round dough pieces are next pressed by hand into discs approximately 12.7 mm (0.5 inch) thick;
G. The dough discs are processed through a sheeting machine with a gap 1 setting at 4.5. The dough pieces are then folded into thirds with the edges trimmed;
H. The dough pieces are next rotated 90 degrees and passed through the sheeting machine gap 1 again with the gap set at 2.5. The dough pieces are then folded into thirds with the edges trimmed;
I. The dough pieces are next rotated 90 degrees, slightly dusted with flour, and passed through the sheeting machine gap 2 with the gap setting at 1.5 to 1.75;
J. The dough is cut into the desired shape and each piece is pierced with a fork so the crackers will be crispy when finished;
K. The dough pieces are baked at 232° C. (450° F.) for 6 minutes, removed from the oven, cooled and placed in a sealed plastic bag.

The results were crackers that have an increased amount of n-3 PUFAs, but retain the taste, structure, aroma, and mouthfeel of typical cracker products currently on the market. The product delivered a substantial amount of omega-3, 383 mg SDA per 16 g serving against a target of 375 mg SDA per serving.

### Example 3

### Apple Cinnamon Baked Bar

The following example relates to a method for making a baked bar that contains a quantity of SDA enriched soybean oil.

The baked bar was made according to the following process. Table 3 is the list of ingredients and the amount used including percentage by weight and kilograms.

TABLE 3

| | | Soybean | SDA |
|---|---|---|---|
| | | Oil | enriched |
| | | Control | soybean |
| Ingredients | % | (kg) | oil (kg) |
| High gluten bread flour | 23.23 | 69.69 | 69.69 |
| Apple filling | 47.53 | 142.59 | 142.59 |
| Crystalline fructose | 6.84 | 20.52 | 20.52 |
| Commercial soybean oil | 5.57 | 16.72 | 0.00 |
| SDA enriched soybean oil | | 0.00 | 16.72 |
| Rolled Oats | 5.03 | 15.09 | 15.09 |
| Brown Rice Syrup | 1.83 | 5.49 | 5.49 |
| Honey | 5.11 | 15.33 | 15.33 |
| Water | 2.92 | 8.76 | 8.76 |
| Glycerin (99.7%) | 0.97 | 2.91 | 2.91 |
| Baking Powder | 0.31 | 0.93 | 0.93 |
| Baking Soda | 0.25 | 0.75 | 0.75 |
| Salt | 0.21 | 0.63 | 0.63 |
| De-oiled Soy Lecithin | 0.10 | 0.30 | 0.30 |
| Vanilla Extract | 0.05 | 0.15 | 0.15 |
| λ (lambda) Carrageenan | 0.05 | 0.15 | 0.15 |
| Total | 100.00 | 300.01 | 300.01 |

The ingredients were combined and processed according to the following steps to produce the baked bar:

### (1) Dough Preparation

A. Oil, lecithin, sugar (⅔ portion) and salt were added to a Hobart mixer, and mixed at low speed for 3 minutes;

B. Remaining Sugar (⅓ portion) and carrageenan were dry-mixed in a separate Hobart mixer, water, brown rice syrup, glycerin and vanilla extract were added to the dry-mixed sugar and carrageenan mixture and blended thoroughly;

C. The mixture from step B and honey were added to the mixture from step A, and mixed at high speed for 2 minutes in a Hobart mixer;

D. Rolled oats, wheat flour, baking powder and baking soda were added to the mixture from step C, and mixed at high speed for 4 minutes in a Hobart mixer;

E. The mixer was scraped, and mixed at low speed for another 1 minute.

### (2) Co-Extruding

A. Dough and apple filling were pushed out through co-extruder.

B. Weight of bars on the conveyer was adjusted before baking.

### (3) Baking

A. Bars from co-extruder were moved through conveyer belt, and went through oven for baking.

B. Bars were baked for about 7 minutes in 3 different temperature zones (230° C., 200° C., 170° C.);

### (4) Cooling and Packaging

A. Baked bars were continuously moved to cooling tunnel (ambient temperature), and then moved to packaging line;

B. Baked bars were packaged individually in multi-layer high barrier film.

The results were a baked bar composition that had an increased amount of n-3 PUFAs, but retains the taste, structure, aroma, and mouthfeel of baked bar products currently on the market. The product delivered a substantial amount of omega-3, 449 mg SDA per 37 g serving against the target of 375 mg SDA per serving.

### Example 4

### Sensory Profiling of Apple Cinnamon Baked Bars

Sensory descriptive analysis was conducted on apple cinnamon baked bars over the 6 month shelf life, testing was conducted at Time 0 and 6 Months at 25° C. to understand the attribute differences of Soybean Oil and SDA Oil in apple cinnamon baked bars. At Time 0 there were seven (7) panelists and at 6 Months there were five (5) panelists; all the panelists were trained in the Sensory Spectrum™ Descriptive Profiling method. The panelists evaluated the samples for 25 flavor attributes and 24 texture attributes. The attributes were evaluated on a 15-point scale, with 0=none/not applicable and 15=very strong/high in each sample. Definitions of the flavor attributes are given in Table 4 and definitions of the texture attributes are given in Table 5.

The bars had the ends cut off, then the bar was cut down the middle and then cut into thirds. Six (6) pieces were placed into three (3) ounce cups with lids and give to panelists. The samples were presented monadically in duplicate.

The data was analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

TABLE 4
Flavor Attribute Lexicon.

| Attribute | Definition | Reference | |
|---|---|---|---|
| | | Intensities based on | |
| | | Universal Scale: | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 12.0 |
| AROMATICS | | | |
| Overall Flavor Impact | The overall intensity of the product aromas, an | | |
| | amalgamation of all perceived aromatics, basic tastes | | |
| | and chemical feeling factors. | | |
| Sweet Aromatics | The general category of aromatics associated with | | |
| Complex | sweet foods. | | |
| vanilla/vanillin | The aromatics associated with vanilla, including | Vanilla Extract, Vanillin | |
| | artificial vanilla, woody, and browned notes. | crystals | |
| caramelized | The aromatics associated with browned sugars such as | Caramelized sugar | |
| | caramel. | | |
| corn syrup | Flavor associated with products sweetened with corn | Dark Corn Syrup, Light corn | |
| | syrup. | syrup | |
| maple | A sweet aromatic characterized as a caramelized, | Maple syrup | |
| | woody, vanilla-like blend of notes | | |
| honey | The sweet, caramelized flavor and wood aromatic | Honey | |
| | associated with honey | | |
| Grain | The aromatics associated with the total grain impact, | All-purpose flour paste, | |
| | which may include all types of grain and different | cream of wheat, whole wheat | |
| | stages of heating. May include wheat, whole wheat, | pasta | |
| | oat, rice, graham, etc | | |
| Fatty | The sweet aromatic associated with animal fats. | Unsalted Butter | |
| Apple Complex | The general category used to describe the total apple | | |
| | flavor impact of the product | | |
| Apple, Artificial | The slight painty, metallic, and pomme aromatics | Apple Jolly Rancher | |
| | associated with artificial apple. | | |
| Apple, Cooked | Flat, slightly sour aroma and taste of cooked apples. | Mott's Natural apple sauce. | |
| Apple, Fresh | Fresh apple top-notes as perceived by mouth | Freshly harvested ripe apples. | |
| Brown Spice/Cinnamon | The sweet aromatic associated with cloves, cinnamon, | Cinnamon solution | |
| | mace and nutmeg. | | |
| Nutty | The aromatics associated with a nutty/woody flavor; | Most tree nuts: pecans, | |
| | also a characteristic of walnuts and other nuts. | almonds, hazelnuts, walnuts, | |
| | Includes hulls/skins of nuts and benzaldehyde. | (E,Z)-2,4 Heptenal, | |
| | | Benzaldehyde. | |
| Cardboard | The aromatics associated with dried wood and the | Toothpicks, Water from | |
| | aromatics associated with slightly oxidized fats and | cardboard soaked for 1 hour | |
| | oils, reminiscent of a cardboard box. | | |
| Fishy/Pondy Complex | The aroma/aromatics associated with triethylamine, | | |
| | pond water or aged fish. The general term used to | | |
| | describe fish meat, which cannot be tied to a specific | | |
| | fish by name. | | |
| Fishy | Aromatic associated with trimethylamine and old fish. | Oxidized tea bag, dried | |
| | | parsley, cod liver oil | |
| Pondy | The aromas and aromatics associated with water | Algal oil (Martek 30% DHA | |
| | containing algae, reminiscent of pond water and | oil) | |
| | aquatic tanks. | | |
| Painty | The solvent aromatic associated with linseed oils and | Aroma of Linseed oil | |
| | moderately oxidized oil. | | |
| BASIC TASTES | | Sucrose solution: | |
| Sweet | The taste on the tongue stimulated by sucrose | 2% | 2.0 |
| | and other sugars, such as fructose, glucose, etc., | 5% | 5.0 |
| | and by other sweet substances, such as | 10% | 10.0 |
| | saccharin, Aspartame, and Acesulfam-K. | 16% | 15.0 |
| | | Citric acid solution: | |
| Sour | The taste on the tongue stimulated by acid, such | 0.05% | 2.0 |
| | as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with sodium | 0.2% | 2.0 |
| | salts. | 0.35% | 5.0 |
| | | 0.5% | 8.5 |
| | | 0.55% | 10.0 |
| | | 0.7% | 15.0 |
| | | Caffeine solution: | |
| Bitter | The taste on the tongue associated with caffeine | 0.05% | 2.0 |
| | and other bitter substances, such as quinine and | 0.08% | 5.0 |
| | hop bitters. | 0.15% | 10.0 |
| | | 0.20% | 15.0 |
| CHEMICAL FEELING | | | |
| FACTOR | | Alum solution: | |
| Astringent | The shrinking or puckering of the tongue surface | 0.005% | 3.0 |
| | caused by substances such as tannins or alum. | 0.0066% | 5.0 |
| | | 0.01% | 9.0 |

| | | |
|---|---|---|
| Burn | A chemical feeling factor associated with high | Lemon juice, vinegar. |
| | concentration of irritants to the mucous | |
| | membranes of the oral cavity. | |

TABLE 5
Texture Attribute Lexicon

| | | |
|---|---|---|
| Attribute | Definition | Reference Scale |

SURFACE

| | | |
|---|---|---|
| Loose particles | The amount of particles remaining on the lip | 0.0 Gummi Bear |
| | surface. | 7.5 Pringles Potato Chip |
| | None - - - Many | 15.0 Powdered Sugar Donut |
| Roughness (Overall) | The amount of particles (small/all) in the | 0.0 Gelatin dessert |
| | surface. | 5.0 Orange peel |
| | Smooth - - - Rough | 8.0 Pringles potato chip |
| | | 12.0 Quaker Oats hard granola bar |
| | | 15.0 Finn Crisp rye wafer |
| Sticky Lips | The degree to which lips are left sticky after | 1.0 Starburst Candy |
| | surface evaluation. | 6.0 Dried Apricot |
| | Not at all - - - Extremely | 15.0 Marshmallow Fluff |

PARTIAL COMPRESSION

| | | |
|---|---|---|
| Springiness | The amount to which the sample returns to | 0.0 Starburst Candy |
| | its original shape. | 5.0 Pound Cake |
| | Dead - - - Springy | 9.0 Mini Marshmallow |
| | | 15.0 Gummi Bear |

FIRST BITE

| | | |
|---|---|---|
| Hardness | The force to attain a given deformation; the force to | 1.0 Cream Cheese |
| | compress between molars. | 4.5 American Cheese |
| | Soft - - - Hard | 6.0 Goya Stuffed Olives |
| | | 7.0 Frankfurter |
| | | 9.5 Peanuts |
| | | 11.0 Carrots/Almonds |
| | | 14.5 Hard Candy |
| Cohesiveness | The amount to which the sample deforms rather than | 1.0 Corn Muffin |
| | crumbles, cracks or breaks. | 5.0 American Cheese |
| | Breaks/Crumbles - - - Deforms | 8.0 Soft Pretzel |
| | | 11.0-12.0 Candy Chews |
| | | 13.0 Caramel |
| | | 15.0 Chewing Gum |
| Denseness | The compactness of the sample cross-section. | 0.5 Whipped Topping |
| | Airy - - - Dense | 2.5 Marshmallow Top. |
| | | 2.5 Rice Krispies |
| | | 4.0 Club Crackers |
| | | 6.0 Malted Milk Balls |
| | | 9.0 Frankfurter |
| | | 15.0 Fruit Jelly Candy |
| Uniformity of Bite | The evenness of the force throughout the first bite. | 2.0 Choc. Chip I.C. |
| | Non-uniform - - - Uniform | 4.0 DS Oreo |
| | Multi-layered - - - Even | 6.0 Regular Oreo |
| | Uneven/Choppy - - - Even | 8.5 Vienna Fingers |
| | | 10.5 Malted Milk Balls |
| | | 15.0 Caramel |
| Fracturability | The force with which the sample breaks. | 1.0 Corn Muffin |
| | Crumbly - - - Brittle | 2.5 Egg Jumbos |
| | | 4.5 Graham Crackers |
| | | 7.0 Melba Toast/Ginger Snaps |
| | | 10.0 Rye Wafers |
| | | 13.0 Peanut Brittle |
| | | 14.5 Hard Candy |
| Crispness | The pitch at which a product breaks or fractures (rather | 2.0 Granola Bar |
| | than deforms). | 5.0 Club Cracker |
| | Not Crisp/Soggy - - - Very Crisp | 9.5 Bran Flakes Cereal |
| | (Low tone) - - - (High tone) | 11.0 Cheese Crackers |
| | | 14.0 Corn Flakes Cereal |
| Crunchiness | The volume (loudness) of the product as it breaks or | 2.0 Chewy Granola Bar |
| | fractures. | 5.0 Vienna Finger |
| | Not Crunchy/Soggy - - - Crunchy | 7.0 Pretzel Stick |
| | (Low Volume) - - - (High Volume) | 11.0 Ginger Snap |
| | | 13.0 Melba Snack |
| | | 15.0 Corn Nuts |

CHEWDOWN

| | | |
|---|---|---|
| # of Chews to | To bolus - The number of chews required to compress all | |
| Swallow/Bolus | the sample and form a bolus. | |
| | To swallow - The number of chews required to | |
| | form a bolus that can be swallowed (stop @ 15 max) | |
| Moistness of Mass | The amount of wetness/oiliness on the surface of the | 3.0 Pork Rinds |
| | mass. | 6.5 Graham Crackers |
| | Dry - - - Wet/Oily | 13.0 Jell-O Jigglers |
| Cohesiveness of | The amount the chewed sample holds together in a mass. | 0.0 Shoestring Licorice |
| Mass | Loose mass - - - Tight mass | 2.0 Carrots |
| | | 4.0 Mushrooms |
| | | 7.5 Frankfurters |
| | | 10.0 American Cheese |
| | | 14.0 Fig Newton |
| Rate of Breakdown | The amount of product that has broken down at the point | 0.0 100% of product remaining |
| | of bolus. | 2.5 83% |
| | None - - - All | 5 67% |
| | | 7.5 50% of product remaining |
| | | 10 35% |
| | | 12.5 17% |
| | | 15.0 0% of product remaining |
| Roughness of Mass | The amount of roughness on the surface of the mass. | 3.0 American Cheese |
| | Smooth - - - Rough | 5.0 Graham Crackers |
| | | 7.5 Melba Toast |
| | | 10.0 Triscut Cracker |
| | | 12.0 Carrots |
| | | 15.0 Granola Bar |
| Moisture | The amount of saliva absorbed by the sample during | 0.0 Shoestring Licorice |
| Absorption | chew down. | 3.5 Red Licorice Sticks |
| | No absorption - - - Large amount of absorption | 7.5 Popcorn |
| | | 10.0 Potato Chips |
| | | 13.0 Pound Cake |
| | | 15.0 Saltine Crackers |
| Fibrous between | The amount of grinding of fibers to get through the | 2.5 Apricots |
| Teeth | sample. | 3.5-4.0 Apple |
| | Not Fibrous - - - Very Fibrous | 4.5-5.0 Salami |
| | | 9.0 Celery |
| | | 10.0 Toasted Oats |
| | | 12.0 Bacon |
| | | 20.0 Beef Jerky |
| Persistence of | The number of chews necessary to change the tonal | |
| Crisp/Crunch | quality. | |
| Toothpull | The increase in force required to separate teeth due to the | 1.0 American Cheese |
| | sample. | 9.0-10.0 Starburst Candy (1st |
| | No force - - - Strong force | Chew) |
| | | 15.0 Caramel (1st Chew) |

RESIDUAL

| | | |
|---|---|---|
| Toothpack | The amount of product packed in the crevices (molars) of | 0.0 Mini clams |
| | the teeth after mastication of the product. | 1.0 Fresh carrots |
| | None - - - A lot | 3.0 Mushrooms |
| | | 7.5 Graham Crackers |
| | | 9.0 American Cheese |
| | | 11.0 Cheese Doodles/puffs |
| | | 15.0 Jujubees |
| Toothstick | The amount of product adhering on the sides of the teeth | 1.0-2.0 Club Cracker |
| | after mastication of the product. | 15.0 Starburst Candy |
| | None - - - A lot | |
| Loose Particles | The amount of particles remaining in the oral cavity after | 0.0 Miracle Whip |
| | expectoration/consumption of the sample. | 0.0 Silk |
| | None - - - A lot | 5.0 Sour cream + cream of |
| | | wheat |
| | | 10.0 Mayo + corn flour |
| Mouthcoating | The amount of coating/film remaining in the mouth after | 1.0 Silk (Chalky, Tacky) |
| (Type) | expectoration. | 3.0 Cooked corn starch |
| | None - - - A lot | 8.0 Pureed potato |
| | | 12.0 Tooth powder |

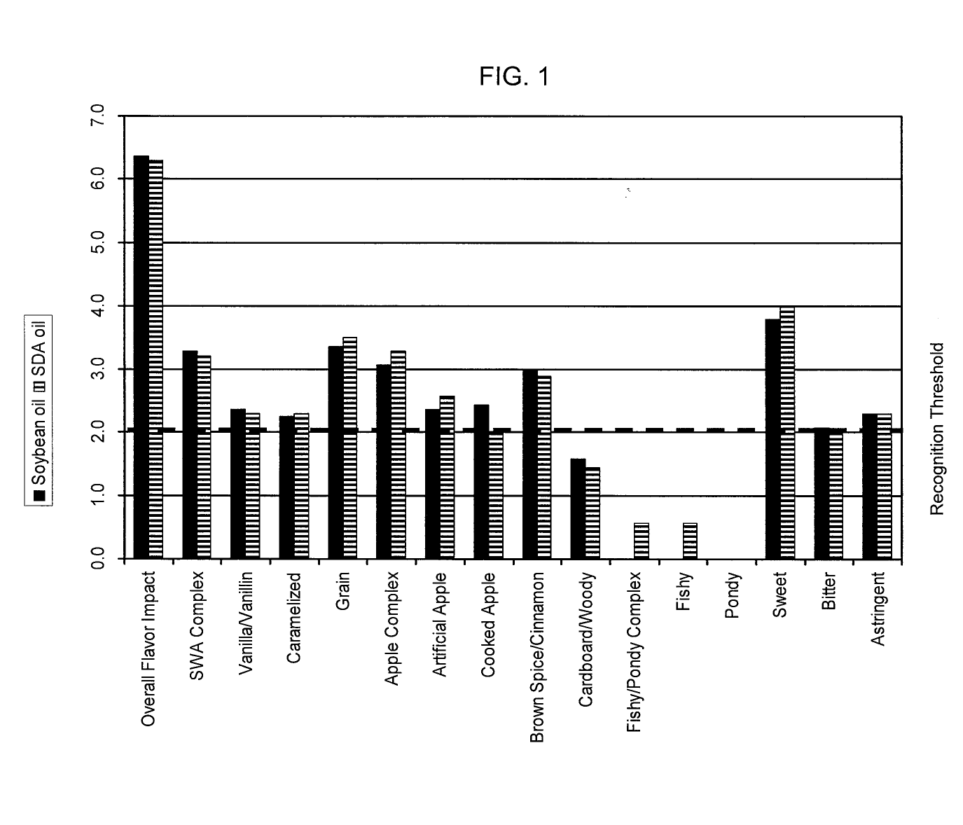

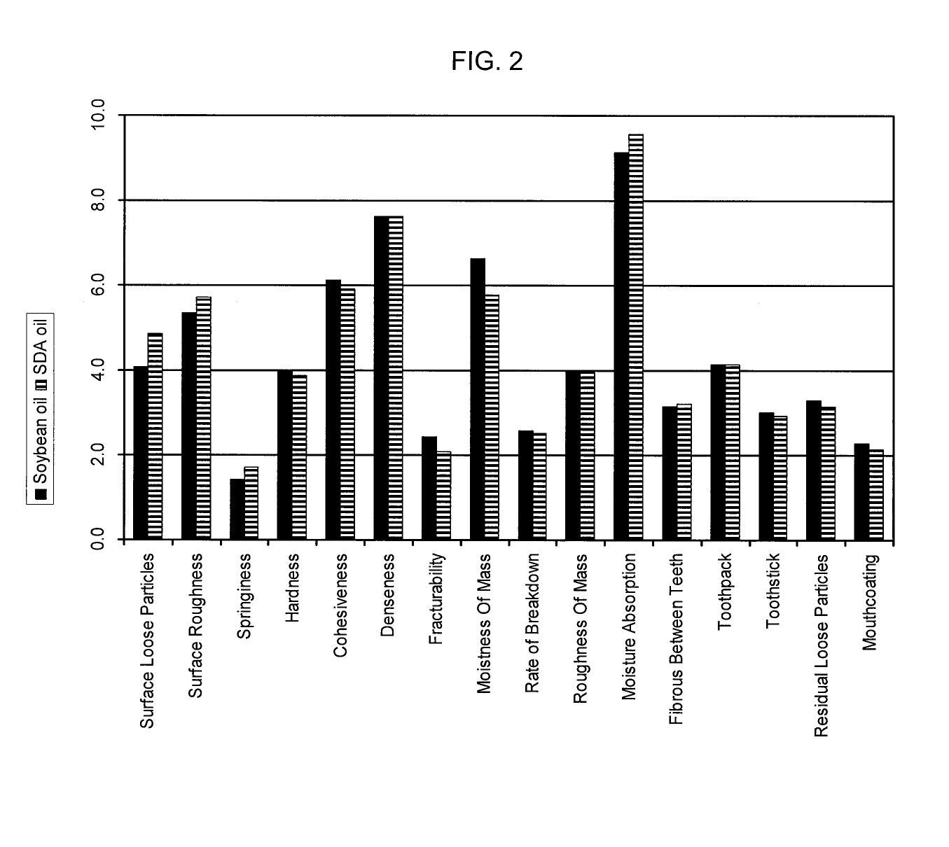

There were detectable differences between the Soybean Oil and SDA Oil apple cinnamon baked bars at Time 0, shown in Table 6 and Table 7. At Time 0, the Soybean Oil apple cinnamon baked bar was higher in Hardness, Fracturability, and Moistness of Mass (FIG. 1 and FIG. 2). The Soybean Oil apple cinnamon baked bar also had Burnt aromatics, which were probably due to processing.

At Time 0, the SDA Oil apple cinnamon baked bar was higher in Grain aromatics, Apple Complex, Cardboard/Woody aromatics, Fishy/Pondy Complex, Fishy aromatics, Sweet basic taste, Surface Loose Particles, Surface Roughness, Springiness, and Moisture Absorption (FIG. 1 and FIG. 2). The Fishy/Pondy Complex and Fishy aromatics were below the recognition threshold (2.0); therefore normal consumers would not be able to detect these aromatics in the sample.

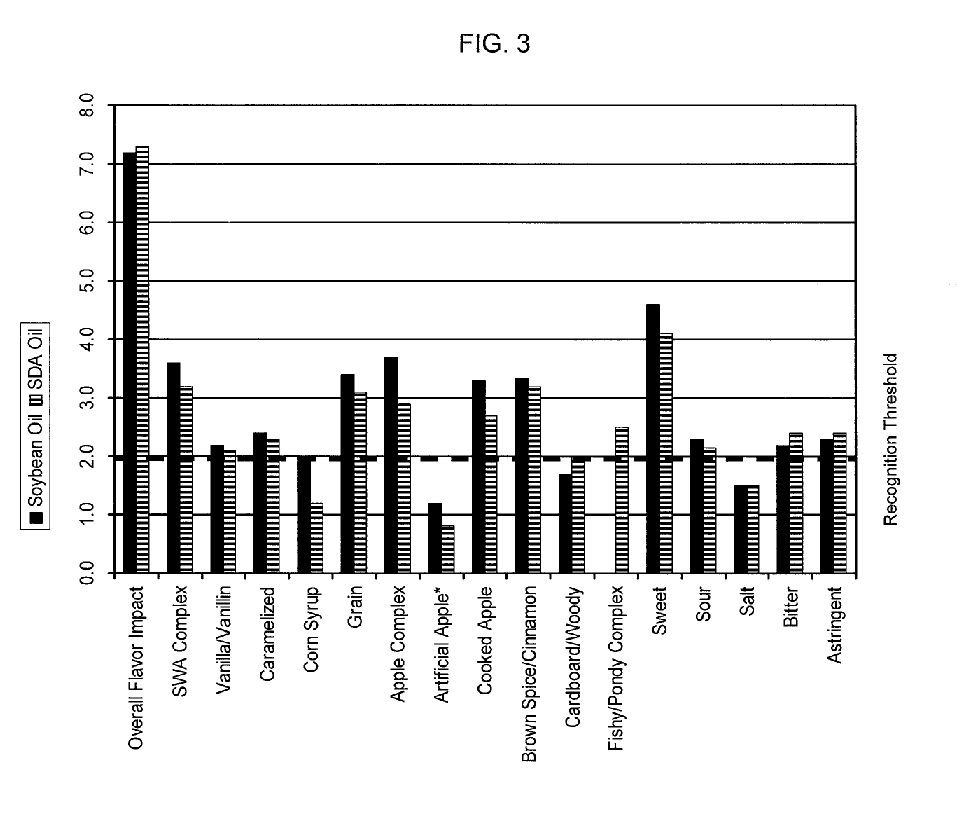

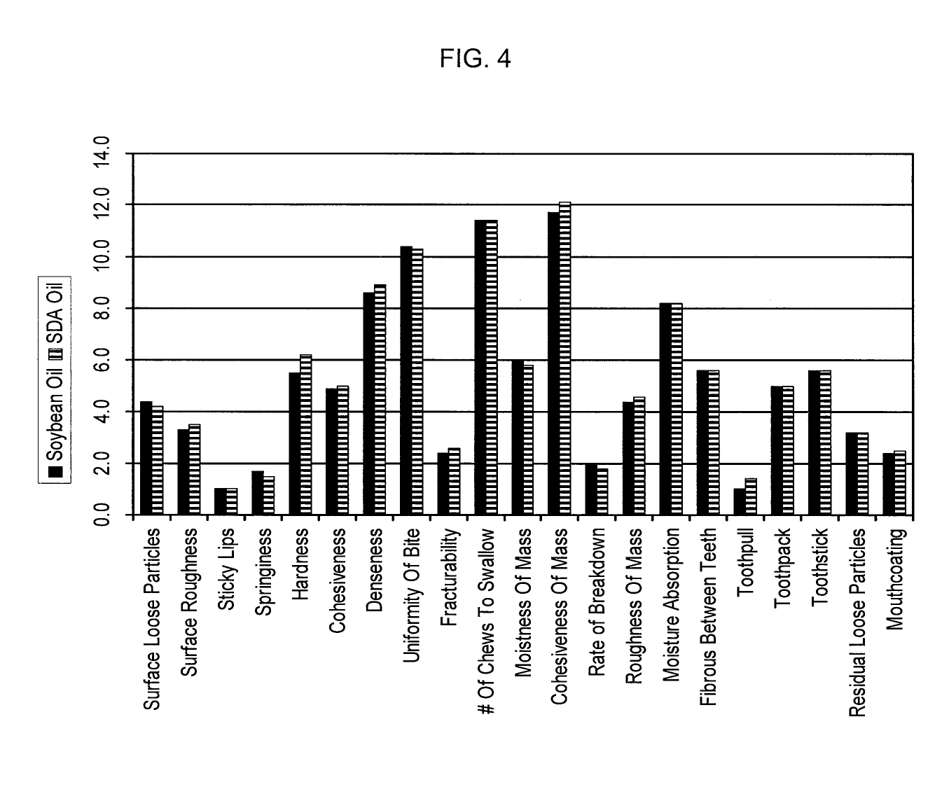

There were detectable differences between Soybean Oil and SDA Oil apple cinnamon baked bars at 6 Months, shown in Table 8 and Table 9. At 6 Months, the Soybean Oil apple cinnamon baked bar was higher in Sweet Aromatics (SWA) Complex, Corn Syrup aromatics, Grain aromatics, Apple Complex, Artificial Apple aromatics, Cooked Apple aromatics, and Sweet basic taste (FIG. 3 and FIG. 4).

At 6 Months, the SDA Oil apple cinnamon baked bar was higher in Cardboard/Woody aromatics, Fishy/Pondy Complex, Bitter basic taste, Hardness, Denseness, and Toothpull (FIG. 3 and FIG. 4). The Fishy/Pondy Complex was slightly above the recognition threshold (2.0). For the sample being at the end of shelf life and only at 2.5 intensity, which is the intensity of baking soda in a saltine cracker (see Table 2), this is an acceptable result. In addition, at the end of shelf life for both the Soybean Oil and SDA Oil apple cinnamon baked bar there were no Painty aromatics, which indicates oxidation.

TABLE 6
Mean Scores for Flavor Attributes.

| | Soybean oil | SDA oil | p value |
|---|---|---|---|
| Aromatics | | | |
| Overall Flavor Impact | 6.4 a | 6.3 a | NS |
| SWA Complex | 3.3 a | 3.2 a | * |
| Vanilla/Vanillin | 2.4 a | 2.3 a | * |
| Caramelized | 2.3 a | 2.3 a | NS |
| Corn Syrup | 0.3 a | 0.3 a | NS |
| Maple | 0.0 | 0.0 | n/a |
| Honey | 0.0 | 0.0 | n/a |
| Other SWA | 0.0 | 0.0 | n/a |
| Grain | 3.4 b | 3.5 a | *** |
| Fatty | 0.0 | 0.0 | n/a |
| Apple Complex | 3.1 b | 3.3 a | *** |
| Artificial Apple | 2.4 a | 2.6 a | NS |
| Cooked Apple | 2.4 a | 2.0 a | * |
| Fresh Apple | 0.0 | 0.0 | n/a |
| Brown Spice/Cinnamon | 3.0 a | 2.9 a | NS |
| Nutty | 0.0 | 0.0 | n/a |
| Cardboard | 1.6 b | 1.4 a | *** |
| Fishy/Pondy Complex | 0.0 b | 0.6 a | *** |
| Fishy | 0.0 b | 0.6 a | *** |
| Pondy | 0.0 b | 0.0 b | NS |
| Painty | 0.0 | 0.0 | n/a |
| Other Aromatic: Burnt | 2.5 (14%) | 0.0 | |
| Basic Tastes & Feeling | | | |
| Factors | | | |
| Sweet | 3.8 b | 4.0 a | *** |
| Sour | 1.9 a | 1.9 a | NS |
| Salt | 0.9 a | 0.9 a | NS |
| Bitter | 2.1 a | 2.0 a | NS |
| Astringent | 2.3 a | 2.3 a | NS |

Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

TABLE 7
Mean Scores for Texture Attributes.

| | Soybean oil | SDA oil | p value |
|---|---|---|---|
| Surface | | | |
| Surface Loose Particles | 4.1 b | 4.9 a | *** |
| Surface Roughness | 5.4 b | 5.7 a | ** |
| Partial Compression | | | |
| Springiness | 1.4 b | 1.7 a | *** |
| First Bite | | | |
| Hardness | 4.0 a | 3.9 b | *** |
| Cohesiveness | 6.1 a | 5.9 a | NS |
| Denseness | 7.6 a | 7.6 a | NS |
| Uniformity Of Bite | 11.1 a | 11.0 a | * |
| Fracturability | 2.4 a | 2.1 b | *** |
| ChewDown | | | |
| # Of Chews To Swallow | 11.4 a | 11.4 a | NS |
| Moistness Of Mass | 6.6 a | 5.8 b | *** |
| Cohesiveness Of Mass | 13.4 a | 13.1 a | * |
| Rate of Breakdown | 2.6 a | 2.5 a | NS |
| Roughness Of Mass | 4.0 a | 4.0 a | NS |
| Moisture Absorption | 9.1 b | 9.6 a | *** |
| Fibrous Between Teeth | 3.1 a | 3.2 a | NS |
| Toothpull | 0.7 a | 0.9 a | * |
| Residual | | | |
| Toothpack | 4.1 a | 4.1 a | NS |
| Toothstick | 3.0 a | 2.9 a | * |
| Residual Loose Particles | 3.3 a | 3.1 a | * |
| Mouthcoating | 2.3 a | 2.1 a | * |

Means in the same row followed by the same letter are not significantly different at 95% Confidence.
*** - 3 99% Confidence,
** - 95% Confidence,
* - 90% Confidence,
NS—Not Significant

TABLE 8
Mean Scores for Flavor Attributes.

| | Soybean Oil | SDA Oil | p value |
|---|---|---|---|
| Aromatics | | | |
| Overall Flavor Impact | 7.2 a | 7.3 a | * |
| SWA Complex | 3.6 a | 3.2 b | *** |
| Vanilla/vanillin | 2.2 a | 2.1 a | * |
| Caramelized | 2.4 a | 2.3 a | * |
| Corn syrup | 2.0 a | 1.2 b | ** |
| Maple | 0.0 | 0.0 | n/a |
| Honey | 0.0 | 0.0 | n/a |
| Other SWA | 0.0 | 0.0 | n/a |
| Grain | 3.4 a | 3.1 b | ** |
| Fatty | 0.0 | 0.0 | n/a |
| Apple Complex | 3.7 a | 2.9 b | *** |
| Artificial Apple | 1.2 a | 0.8 b | *** |
| Cooked Apple | 3.3 a | 2.7 b | *** |
| Fresh Apple | 0.0 | 0.0 | n/a |
| Brown Spice/Cinnamon | 3.4 a | 3.2 a | NS |
| Nutty | 0.0 | 0.0 | n/a |
| Cardboard | 1.7 b | 2.0 a | ** |
| Fishy/Pondy Complex | 0.0 b | 2.5 a | ** |
| Fishy | 0.0 | 0.0 | n/a |
| Pondy | 0.0 | 0.0 | n/a |
| Painty | 0.0 | 0.0 | n/a |
| Basic Tastes & Feeling | | | |
| Factors | | | |
| Sweet | 4.6 a | 4.1 b | *** |
| Sour | 2.3 a | 2.2 a | NS |
| Salt | 1.5 a | 1.5 a | NS |
| Bitter | 2.2 b | 2.4 a | *** |
| Astringent | 2.3 a | 2.4 a | * |
| Burn | 1.1 a | 0.7 a | NS |

Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

TABLE 9
Mean Scores for Texture Attributes.

| | Soybean Oil | SDA Oil | p value |
|---|---|---|---|
| Surface | | | |
| Surface Loose Particles | 4.4 a | 4.2 a | * |
| Surface Roughness | 3.3 a | 3.5 a | * |
| Sticky Lips | 1.0 a | 1.0 a | NS |
| Partial Compression | | | |
| Springiness | 1.7 a | 1.5 a | * |
| First Bite | | | |
| Hardness | 5.5 b | 6.2 a | *** |
| Cohesiveness | 4.9 a | 5.0 a | NS |
| Denseness | 8.6 b | 8.9 a | ** |
| Uniformity Of Bite | 10.4 a | 10.3 a | NS |
| Fracturability | 2.4 a | 2.6 a | * |
| Crispness | 0.0 | 0.0 | n/a |
| Crunchiness | 0.0 | 0.0 | n/a |
| ChewDown | | | |
| # Of Chews To Swallow | 11.4 a | 11.4 a | NS |
| Moistness Of Mass | 6.0 a | 5.8 a | * |
| Cohesiveness Of Mass | 11.7 a | 12.1 a | * |
| Rate of Breakdown | 2.0 a | 1.8 a | * |
| Roughness Of Mass | 4.4 a | 4.6 a | * |
| Moisture Absorption | 8.2 a | 8.2 a | NS |
| Fibrous Between Teeth | 5.6 a | 5.6 a | NS |
| Persistence Of Crisp/Crunch | 0.0 | 0.0 | n/a |
| Toothpull | 1.0 a | 1.4 a | *** |
| Residual | | | |
| Toothpack | 5.0 a | 5.0 a | NS |
| Toothstick | 5.6 a | 5.6 a | NS |
| Residual Loose Particles | 3.2 a | 3.2 a | NS |
| Mouthcoating | 2.4 a | 2.5 a | * |

Means in the same row followed by the same letter are not significantly different at 95% Confidence.
*** - 99% Confidence,
** - 95% Confidence,
* - 90% Confidence,
NS—Not Significant

### Example 5

### Sensory Acceptance of Apple Cinnamon Baked Bars

To evaluate sensory parity of Soybean Oil and SDA Oil, consumer acceptability based on Soybean Oil and SDA Oil was analyzed for apple cinnamon baked bars. The acceptance ratings were compared between the Soybean Oil and SDA Oil apple cinnamon baked bars over the 6 month shelf life. Acceptance was conducted at 3 months and at 6 months at 25° C.

The samples at 3 months were evaluated by 37 consumers willing to try apple cinnamon baked bars, prescreened as people who have signed the SDA informed consent. The samples at 6 months were evaluated by 72 consumers willing to try apple cinnamon baked bars. The consumers used a 9-point Hedonic acceptance scale. The Hedonic scale ranged from 1 being dislike extremely to 9 being like extremely and was used for Overall Liking, Appearance Liking, Color Liking, Flavor Liking, Mouthfeel Liking, Texture Liking, and Aftertaste Liking.

Consumers evaluated half a bar with the ends cut off. The samples were served by sequential monadic presentation (one at a time).

The data was analyzed using the Analysis of Variance (ANOVA) to account for panelist and sample effects, with mean separations using Tukey's Significant Difference (HSD) Test.

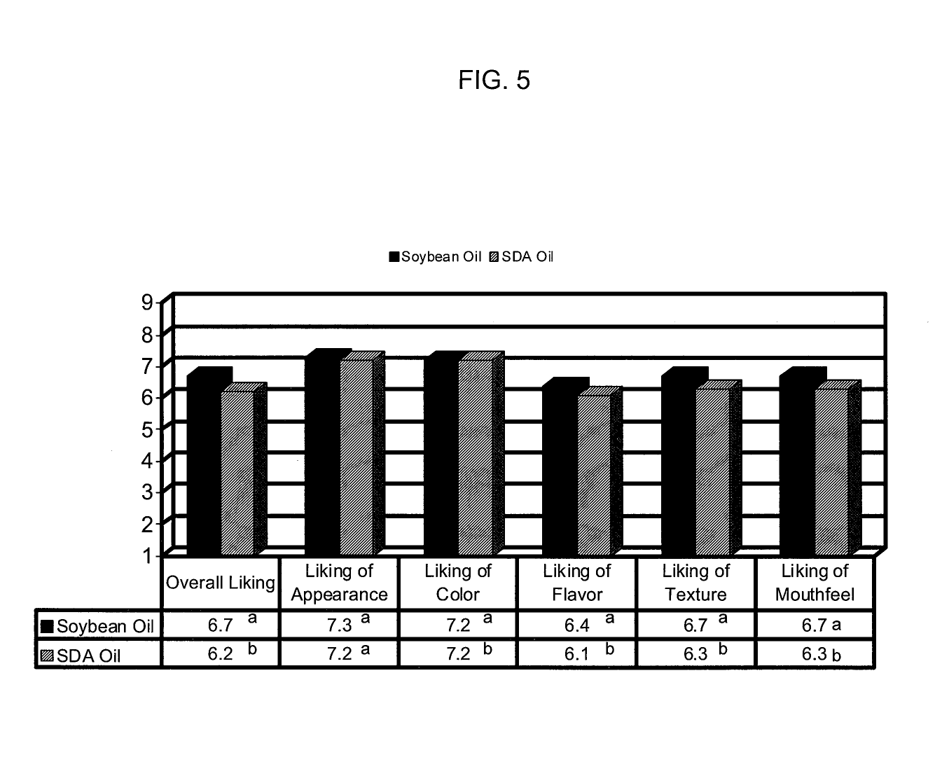

At 3 months of being stored at 25° C., there were no significant differences in Appearance Liking, Color Liking, Flavor Liking, Texture Liking, and Mouthfeel Liking between Soybean Oil and SDA Oil apple cinnamon baked bars (FIG. 5). The mean scores of the Soybean Oil apple cinnamon baked bar was significantly higher compared to the SDA Oil apple cinnamon baked bar in Overall Liking (FIG. 5). Even though there were differences in Overall Liking, this did not affect the liking of appearance, color, flavor, texture, and mouthfeel of the samples.

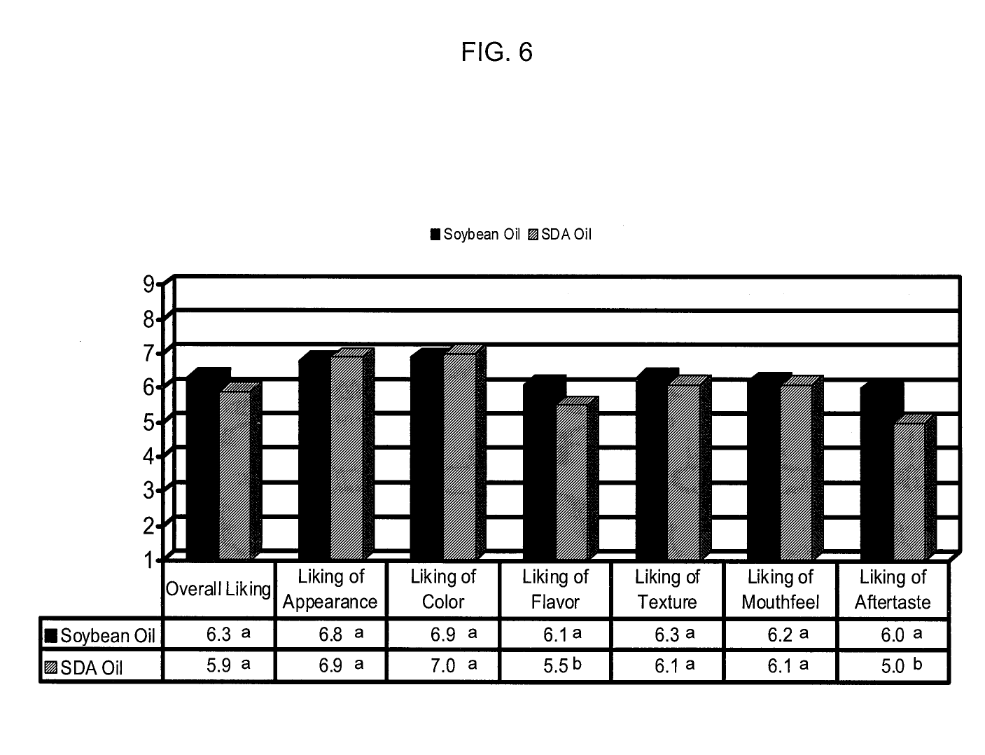

At 6 months of being stored at 25° C. there were no significant differences in Overall Liking, Appearance Liking, Color Liking, Texture Liking, and Mouthfeel Liking between the Soybean Oil and SDA Oil apple cinnamon baked bars (FIG. 6). The mean scores of the Soybean Oil apple cinnamon baked bar were significantly higher compared to the SDA Oil apple cinnamon baked bar in Flavor Liking and Aftertaste Liking (FIG. 6). However, the differences in Flavor Liking and Aftertaste Liking did not affect the Overall Liking of the SDA Oil apple cinnamon bar, which was not significantly different from the Soybean Oil sample.

### Example 6

### Plain Bagel

The following example relates to a method for making a plain bagel that contains an amount of SDA enriched soybean oil.

The plain bagel was made according to the following process. Table 10 is the list of ingredients and the amount used including percentage by weight and grams.

TABLE 10

| | | Control | SDA enriched |
|---|---|---|---|
| | | soybean oil | soybean oil |
| Ingredients | % | (g) | (g) |
| High Gluten Flour | 57.44 | 3000.00 | 3000.00 |
| Sugar | 1.51 | 78.90 | 78.90 |
| Salt | 1.04 | 54.30 | 54.30 |
| Fibrim ® 1270 | 1.15 | 60.00 | 60.00 |
| Soybean Oil | 2.33 | 121.50 | 0.00 |
| SDA Oil | 0.00 | 0.00 | 121.50 |
| Active Dry Bakers Yeast | 0.52 | 27.00 | 27.00 |
| Water | 36.02 | 1881.00 | 1881.00 |
| Total | 100.00 | 5222.70 | 5222.70 |

The ingredients were combined and processed according to the following steps to produce the plain bagel:
1. All dry ingredients were mixed in a Hobart mixer using a hook attachment set at speed #1 for 1 minute;
2. Oil and Water (water temperature was maintained at 10° C.-12.7° C. (50° F.-55° F.), were added to the mixer, the contents were mixed for 1-2 minutes;
3. The speed was then changed to #2 with a 12 minute mixing time, the bagel dough was stiff and slightly tacky. The temperature of the dough was 26° C.-27° C. (80° F. -82° F.) after mixing;
4. The dough rested for 5 minutes after which the dough was scaled into 78 g (2.75 ounce) size to make individual bagels;
5. The bagel was first shaped into a ball by rolling the piece of dough on a dampened counter with the palm of the hand. Then the ball was rolled out to make 20.3-25.4 cm (8-10″) roll and the ends squeezed together to form the bagel shape, which was then placed on a cornmeal-coated tray;
6. The proof box was set at a wet bulb temperature of 35.6° C. (96° F.) and a dry bulb temperature of 33.3° C. (92° F.);
7. The bagels were placed in the proof box for 20 minutes, after which they were chilled in a refrigerator (4° C.) for 30 minutes;
8. Bagels were boiled in water (containing 2% potassium sorbate according to amount of water) for 1 minute they were then flipped using a slotted spoon and boiled for another 1 minute;
9. The bagels were returned to the lined cornmeal-coated baking sheet and placed in the oven;
10. Bagels were baked at 232° C. (450° F.) for 15 minutes after which they were cooled for 30 minutes on a bread rack. Approximately 60 bagels were produced per batch with an average bake weight of 72 g.

The results were bagels that have an increased amount of n-3 PUFAs, but retain the taste, structure, aroma, and mouthfeel of typical bagel products currently on the market. The product delivered 375 mg SDA per 72 g serving size against the target of 375 mg SDA per serving.

### Example 7

### Profiling of Plain Bagel

Sensory descriptive analysis was conducted on plain bagels to understand the attribute differences of Soybean Oil and SDA Oil in plain bagels. Eight panelists trained in the Sensory Spectrum™ Descriptive Profiling method evaluated the samples for 20 flavor attributes, 15 texture attributes, and 3 aftertaste attributes. The attributes were evaluated on a 15-point scale, with 0=none/not applicable and 15=very strong/high in each sample. Definitions of the flavor attributes are given in Table 11 and definitions of the texture attributes are given in Table 12.

The samples were cut in half, so the panelists would receive portions of both the top and bottom pieces. The samples were presented monadically in triplicate.

The data was analyzed using the Analysis of Variance (ANOVA) to test product and replication effects. When the ANOVA result was significant, multiple comparisons of means were performed using the Tukey's HSD t-test. All differences were significant at a 95% confidence level unless otherwise noted. For flavor attributes, mean values <1.0 indicate that not all panelists perceived the attribute in the sample. A value of 2.0 was considered recognition threshold for all flavor attributes, which was the minimum level that the panelist could detect and still identify the attribute.

TABLE 11
Flavor Attribute Lexicon.

| Attribute | Definition | Reference | |
|---|---|---|---|
| | | Intensities based on | |
| | | Universal Scale: | |
| | | Baking Soda in Saltine | 2.5 |
| | | Cooked Apple in Applesauce | 5.0 |
| | | Orange in Orange Juice | 7.5 |
| | | Concord Grape in Grape Juice | 10.0 |
| | | Cinnamon in Big Red Gum | 15.0 |
| Aromatics | | | |
| Overall Flavor Impact | The overall intensity of the product aromas, an amalgamation | | |
| | of all perceived aromatics, basic tastes and chemical feeling | | |
| | factors. | | |
| Grain Complex | The aromatics associated with the total grain impact, which | | |
| | may include all types of grain and different stages of heating. | | |
| | May include wheat, whole wheat, oat, rice, graham, corn, etc | | |
| Raw | The aromatics associated with uncooked grains. | All-purpose flour paste | |
| Cooked | The aromatics associated with cooked grains. (Include the | Cream of Wheat | |
| | browned note you get on top of bagel) | | |
| Toasted | Aromatics associated with grains that have been gently | Wheaties, Corn Flakes, | |
| | heated/or toasted with a nutty, caramelized, browned | toasted white bread | |
| | character of Maillard browned grains | | |
| Yeasty/Fermented | The aromatics associated with fresh yeast and fermentation. | Water suspension of Baker's | |
| | | dry yeast | |
| Eggy | Aromatics associated with boiled eggs, boiled old-egg | Hard boiled eggs, freshly | |
| | proteins or hydrogen sulfide gas. | peeled | |
| Oil | Aromatics and flavor notes reminiscent of vegetable oil or | Vegetable Oil | |
| | mineral oil products | | |
| Musty | Aromatic associated with closed air spaces such as attics and | Damp cloth stored in plastic | |
| | closets (dry) and basements (wet). | bag, old books, white pepper | |
| Cardboard/Woody | The aromatics associated with dried wood and the aromatics | Toothpicks, Water from | |
| | associated with slightly oxidized fats and oils, reminiscent of | cardboard soaked for 1 hour | |
| | a cardboard box. | | |
| Painty | The solvent aromatic associated with linseed oils and | Aroma of Linseed oil | |
| | moderately oxidized oil. | | |
| Fishy/Pondy | The aroma/aromatics associated with triethylamine, pond | | |
| Complex | water or aged fish. The general term used to describe fish | | |
| | meat, which cannot be tied to a specific fish by name. | | |
| Fishy | Aromatic associated with trimethylamine and old fish. | Cod liver oil capsules, | |
| | | trimethylamine, Geisha | |
| | | canned lump crab, tuna in | |
| | | pouch | |
| Pondy | The aromas and aromatics associated with water containing | Algal oil (Martek 30% DHA | |
| | algae, reminiscent of pond water and aquatic tanks. | oil) | |
| BASIC TASTES | | Sucrose solution: | |
| Sweet | The taste on the tongue stimulated by sucrose | 2% | 2.0 |
| | and other sugars, such as fructose, glucose, etc., | 5% | 5.0 |
| | and by other sweet substances, such as | 10% | 10.0 |
| | saccharin, Aspartame, and Acesulfam-K. | 16% | 15.0 |
| | | Citric acid solution: | |
| Sour | The taste on the tongue stimulated by acid, such | 0.05% | 2.0 |
| | as citric, malic, phosphoric, etc. | 0.08% | 5.0 |
| | | 0.15% | 10.0 |
| | | 0.20% | 15.0 |
| | | Sodium chloride solution: | |
| Salt | The taste on the tongue associated with sodium | 0.2% | 2.0 |
| | salts. | 0.35% | 5.0 |
| | | 0.5% | 8.5 |
| | | 0.55% | 10.0 |
| | | 0.7% | 15.0 |
| | | Caffeine solution: | |
| Bitter | The taste on the tongue associated with caffeine | 0.05% | 2.0 |
| | and other bitter substances, such as quinine and | 0.08% | 5.0 |
| | hop bitters. | 0.15% | 10.0 |
| | | 0.20% | 15.0 |
| CHEMICAL FEELING | | | |
| FACTOR | | Alum solution: | |
| Astringent | The shrinking or puckering of the tongue surface | 0.005% | 3.0 |
| | caused by substances such as tannins or alum. | 0.0066% | 5.0 |
| | | 0.01% | 9.0 |

| | | |
|---|---|---|
| Burn | A chemical feeling factor associated with high | Lemon juice, vinegar. |
| | concentration of irritants to the mucous | |
| | membranes of the oral cavity. | |

TABLE 12
Texture Attribute Lexicon

| | | |
|---|---|---|
| Attribute | Definition | Reference Scale |

SURFACE

| | | |
|---|---|---|
| Roughness (Overall) | The amount of particles (small/all) in the | 0.0 Gelatin dessert |
| | surface. | 5.0 Orange peel |
| | Smooth - - - Rough | 8.0 Pringles potato chip |
| | | 12.0 Quaker Oats hard granola bar |
| | | 15.0 Finn Crisp rye wafer |
| Loose particles | The amount of particles remaining on the lip | 0.0 Gummi Bear |
| | surface. | 7.5 Pringles Potato Chip |
| | None - - - Many | 15.0 Powdered Sugar Donut |

PARTIAL COMPRESSION

| | | |
|---|---|---|
| Springiness | The amount to which the sample returns to | 0.0 Starburst Candy |
| | its original shape. | 5.0 Pound Cake |
| | Dead - - - Springy | 9.0 Mini Marshmallow |
| | | 15.0 Gummi Bear |

FIRST BITE

| | | |
|---|---|---|
| Hardness | The force to attain a given deformation; the | 1.0 Cream Cheese |
| | force to compress between molars. | 4.5 American Cheese |
| | Soft - - - Hard | 6.0 Goya Stuffed Olives |
| | | 7.0 Frankfurter |
| | | 9.5 Peanuts |
| | | 11.0 Carrots/Almonds |
| | | 14.5 Hard Candy |
| Denseness | The compactness of the sample cross- | 0.5 Whipped Topping |
| | section. | 2.5 Marshmallow Top. |
| | Airy - - - Dense | 2.5 Rice Krispies |
| | | 4.0 Club Crackers |
| | | 4.0 Nougat |
| | | 6.0 Malted Milk Balls |
| | | 9.0 Frankfurter |
| | | 15.0 Fruit Jelly Candy |
| Cohesiveness | The amount to which the sample deforms | 1.0 Corn Muffin |
| | rather than crumbles, cracks or breaks. | 5.0 American Cheese |
| | Breaks/Crumbles - - - Deforms | 8.0 Soft Pretzel |
| | | 11.0-12.0 Candy Chews |
| | | 13.0 Caramel |
| | | 15.0 Chewing Gum |

CHEWDOWN

| | | |
|---|---|---|
| Moistness of Mass | The amount of wetness/oiliness on the surface of the | 3.0 Pork Rinds |
| | mass. | 6.5 Graham Crackers |
| | Dry - - - Wet/Oily | 13.0 Jell-O Jigglers |
| Moisture | The amount of saliva absorbed by the sample during | 0.0 Shoestring Licorice |
| Absorption | chew down. | 3.5 Red Licorice Sticks |
| | No absorption - - - Large amount of absorption | 7.5 Popcorn |
| | | 10.0 Potato Chips |
| | | 13.0 Pound Cake |
| | | 15.0 Saltine Crackers |
| Roughness of Mass | The amount of roughness on the surface of the mass. | 3.0 American Cheese |
| | Smooth - - - Rough | 5.0 Graham Crackers |
| | | 7.5 Melba Toast |
| | | 10.0 Triscut Cracker |
| | | 12.0 Carrots |
| | | 15.0 Granola Bar |
| Cohesiveness of | The amount the chewed sample holds together in a mass. | 0.0 Shoestring Licorice |
| mass | Loose mass - - - Tight mass | 2.0 Carrots |
| | | 4.0 Mushrooms |
| | | 7.5 Frankfurters |
| | | 10.0 American Cheese |
| | | 14.0 Fig Newton |
| Toothpull | The increase in force required to separate teeth due to the | 1.0 American Cheese |
| | sample. | 9.0-10.0 Starburst Candy (1st |
| | No force - - - Strong force | Chew) |
| | | 15.0 Caramel (1st Chew) |

RESIDUAL

| | | |
|---|---|---|
| Toothstick | The amount of product adhering on the sides of the teeth | 1.0-2.0 Club Cracker |
| | after mastication of the product. | 15.0 Starburst Candy |
| | None - - - A lot | |
| Toothpack | The amount of product packed in the crevices (molars) of | 0.0 Mini clams |
| | the teeth after mastication of the product. | 1.0 Fresh carrots |
| | None - - - A lot | 3.0 Mushrooms |
| | | 7.5 Graham Crackers |
| | | 9.0 American Cheese |
| | | 11.0 Cheese Doodles/puffs |
| | | 15.0 Jujubees |
| Loose Particles | The amount of particles remaining in the oral cavity after | 0.0 Miracle Whip |
| | expectoration/consumption of the sample. | 0.0 Silk |
| | None - - - A lot | 5.0 Sour cream + cream of |
| | | wheat |
| | | 10.0 Mayo + corn flour |

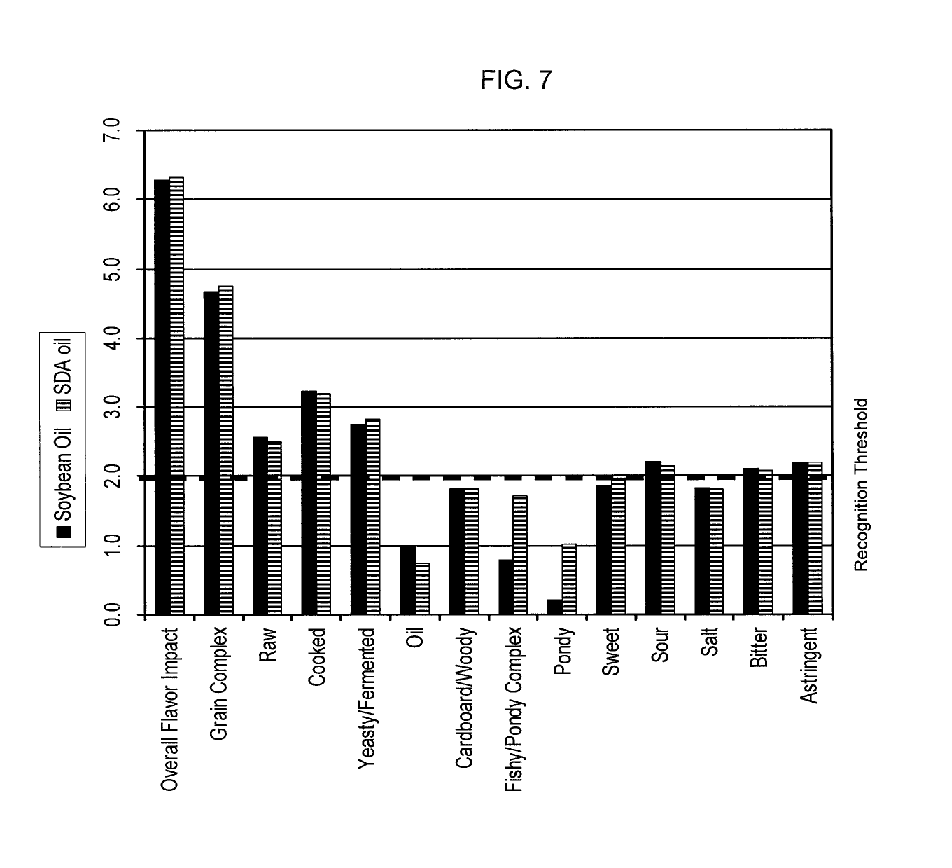

There were detectable differences between the Soybean Oil and SDA Oil plain bagels, shown in Table 13 and Table 14. The Soybean Oil had Dirty aromatics (FIG. 7).

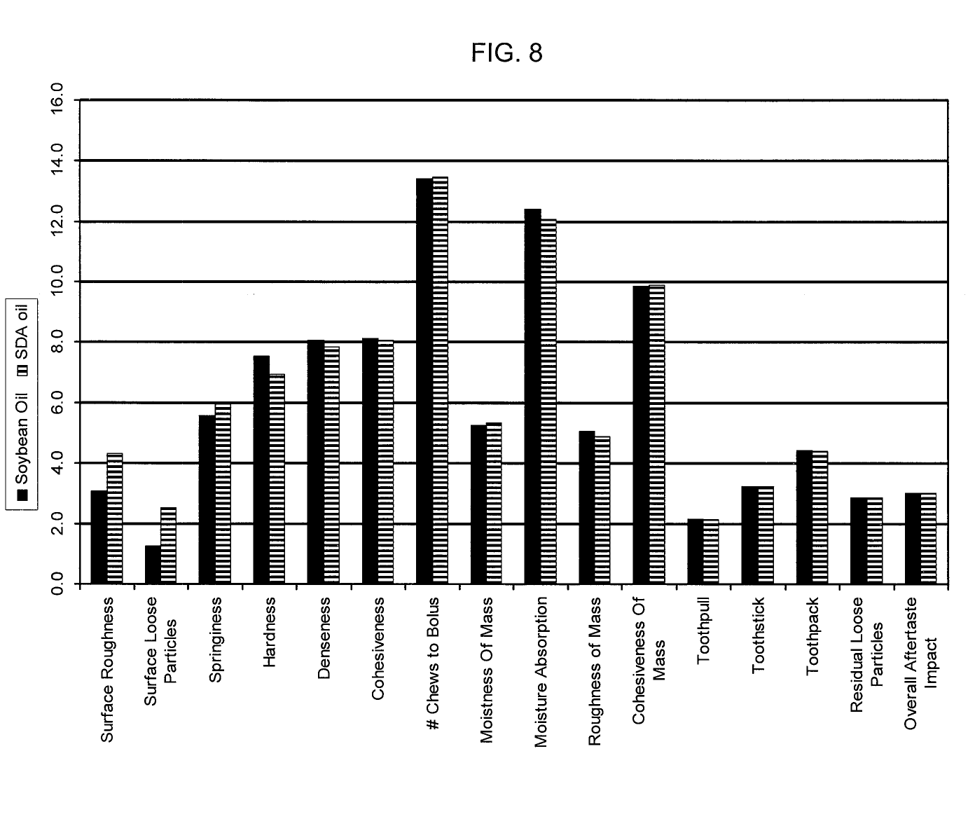

The SDA Oil plain bagel was higher in Fishy/Pondy Complex, Pondy aromatics, and Sweet basic taste (FIG. 7 and FIG. 8). The Fishy/Pondy Complex and Pondy aromatics were below the recognition threshold (2.0), therefore consumers would not be able to detect these aromatics in the sample. Both the Soybean Oil and SDA Oil did not have any off notes such as Painty aromatics, which indicate oxidation.

TABLE 13
Mean Scores for Flavor Attributes.

| | Soybean Oil | SDA Oil | HSD value | p value |
|---|---|---|---|---|
| Aromatics | | | | |
| Overall Flavor Impact | 6.3 a | 6.3 a | 0.145 | NS |
| Grain Complex | 4.7 a | 4.8 a | 0.204 | NS |
| Raw | 2.6 a | 2.5 a | 0.210 | NS |
| Cooked | 3.2 a | 3.2 a | 0.206 | NS |
| Toasted | 0.0 a | 0.3 a | 0.286 | * |
| Yeasty/Fermented | 2.8 a | 2.8 a | 0.131 | NS |
| Eggy | 0.3 a | 0.4 a | 0.303 | NS |
| Oil | 1.0 a | 0.8 a | 0.454 | NS |
| Musty | 0.9 a | 0.6 a | 0.406 | * |
| Cardboard/Woody | 1.8 a | 1.8 a | n/a | n/a |
| Painty | 0.0 | 0.0 | n/a | n/a |
| Fishy/Pondy | 0.8 b | 1.7 a | 0.570 | *** |
| Complex | | | | |
| Fishy | 0.3 a | 0.1 a | 0.371 | NS |
| Pondy | 0.2 b | 1.0 a | 0.498 | *** |
| Other Aromatic: Dirty | 2.0 (13%) | 0.0 | | |
| Basic Tastes & | | | | |
| Feeling Factors | | | | |
| Sweet | 1.9 b | 2.0 a | 0.089 | ** |
| Sour | 2.2 a | 2.2 a | 0.116 | NS |
| Salt | 1.8 a | 1.8 a | 0.116 | NS |
| Bitter | 2.1 a | 2.1 a | 0.043 | NS |
| Astringent | 2.2 a | 2.2 a | n/a | NS |
| Burn | 0.2 a | 0.2 a | 0.152 | NS |
| Aftertaste | | | | |
| Overall Aftertaste | 3.0 a | 3.0 a | 0.116 | NS |
| Impact | | | | |
| Fishy Aftertaste | 0.0 | 0.0 | n/a | n/a |
| Pondy Aftertaste | 0.0 | 0.0 | n/a | n/a |

Means in the same row followed by the same letter are not significantly different at 95% Confidence.
*** - 99% Confidence,
** - 95% Confidence,
* - 90% Confidence,
NS—Not Significant
The attributes above threshold are bold. The attributes significant at 90% Confidence are italicized. For other attributes, % score is the percentage of times the attribute was perceived, and the score is reported as an average value of the detectors.

TABLE 14
Mean Scores for Texture Attributes.

| | Soybean Oil | SDA Oil | HSD value | p value |
|---|---|---|---|---|
| Surface | | | | |
| Surface Roughness | 3.1 b | 4.3 a | 0.793 | *** |
| Surface Loose | 1.3 b | 2.5 a | 1.274 | ** |
| Particles | | | | |
| Partial Compression | | | | |
| Springiness | 5.6 a | 6.0 a | 0.698 | NS |
| First Bite | | | | |
| Hardness | 7.5 a | 6.9 b | 0.334 | *** |
| Denseness | 8.1 a | 7.8 a | 0.561 | NS |
| Cohesiveness | 8.1 a | 8.1 a | 0.408 | NS |
| # Chews to Bolus | 13.4 a | 13.5 a | 0.152 | NS |
| Chewdown | | | | |
| Moistness Of Mass | 5.3 a | 5.4 a | 0.372 | NS |
| Moisture Absorption | 12.4 a | 12.1 b | 0.239 | *** |
| Roughness of Mass | 5.1 a | 4.9 a | 0.261 | NS |
| Cohesiveness Of Mass | 9.9 a | 9.9 a | 0.302 | NS |
| Toothpull | 2.2 a | 2.1 a | 0.211 | NS |
| Residual | | | | |
| Toothstick | 3.3 a | 3.3 a | 0.305 | NS |
| Toothpack | 4.4 a | 4.4 a | 0.261 | NS |
| Residual Loose | 2.9 a | 2.9 a | 0.249 | NS |
| Particles | | | | |

Means in the same row followed by the same letter are not significantly different at 95% Confidence.
*** - 99% Confidence,
** - 95% Confidence,
* - 90% Confidence,
NS—Not Significant

### Example 8

### Acceptance of Plain Bagel

To evaluate sensory parity of Soybean Oil and SDA Oil, consumer acceptability based on Soybean Oil and SDA Oil were analyzed for plain bagels. The acceptance ratings were compared between the Soybean Oil and SDA Oil plain bagel.

The samples were evaluated by 52 consumers willing to try bagels, prescreened as bagel likers. The consumers used a 9-point Hedonic acceptance scale. The Hedonic scale ranged from 1 being dislike extremely and 9 being like extremely and was used for Overall Liking, Color Liking, Flavor Liking, Mouthfeel Liking, Texture Liking, and Aftertaste Liking.

Consumers evaluated half a bagel, so they received part of top and bottom of bagel. The samples were served by sequential monadic presentation (one at a time).

The data was analyzed using the Analysis of Variance (ANOVA) to account for panelist and sample effects, with mean separations using Tukey's Significant Difference (HSD) Test.

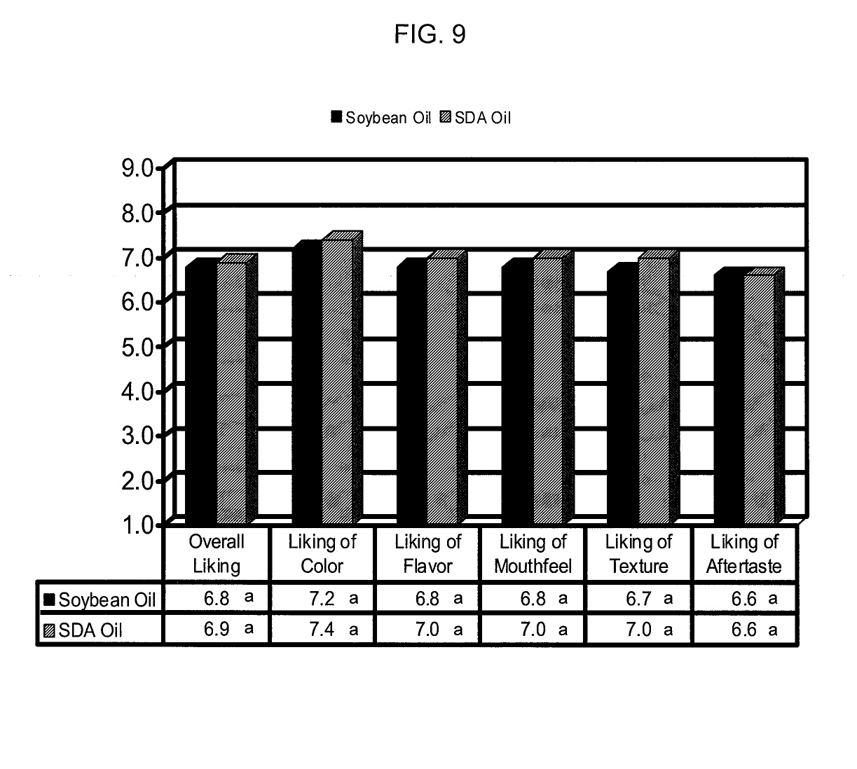

There were no significant differences between the Soybean Oil and SDA Oil plain bagels in Overall Liking, Color Liking, Flavor Liking, Mouthfeel Liking, Texture Liking, and Aftertaste Liking (FIG. 9).

### Example 9

### Chocolate Extruded Bar Formulation

The following example relates to a method of making an extruded type bar that contains an amount of SDA enriched soybean oil.

Table 15 provides detailed amounts of the ingredients.

All of the liquid ingredients, with the exception of the oil, were combined and heated in the microwave for approximately 30 seconds to ease blending. The liquid ingredients, including the oil, were then placed in a Kitchenaid™ mixer and mixed for 1 minute using the flat beater attachment, at speed 3.

All of the dry ingredients were combined in a separate container and mixed by hand until well blended. The dry ingredients were then added to the liquid ingredients in the Kitchenaid™ mixer and mixed for 1 minute, at speed 2, to initially blend after which the speed was increased to speed 4 for an additional 3 minutes.

The resulting mixture was placed on a flat surface and formed into a rectangle. It was then rolled out to approximately 12.7 mm (½ inch) thickness and cut into 50 g servings using a dough cutter.

The chocolate compound was heated in the microwave for approximately 90 seconds to melt it before coating the bars. The bars were allowed to rest for 15 minutes after being coated with the chocolate compound before they were packaged.

This chocolate extruded bar formulation will deliver approximately 375 mg SDA per 50 g serving size of chocolate bar against the target of 375 mg SDA per serving.

TABLE 15
Chocolate Extruded Bar Formulation

| | Control | | | |
|---|---|---|---|---|
| | Soybean | | | |
| | Oil | | SDA Oil | |
| Ingredients: | (%) | (g) | (%) | (g) |
| Soy Protein Isolate | 18.80 | 188.00 | 18.80 | 188.00 |
| Whey Protein Isolate | 5.00 | 50.00 | 5.00 | 50.00 |
| Soy Nugget | 13.60 | 136.00 | 13.60 | 136.00 |
| Glycerin | 4.50 | 45.00 | 4.50 | 45.00 |
| SDA oil | 0.00 | 0.00 | 4.00 | 40.00 |
| Soybean oil | 4.00 | 40.00 | 0.00 | 0.00 |
| Marshmallow flavor | 0.40 | 4.00 | .40 | 4.00 |
| Chocolate flavor | 0.40 | 4.00 | .40 | 4.00 |
| Vanilla flavor | 0.30 | 3.00 | .30 | 3.00 |
| Cocoa Powder | 4.00 | 40.00 | 4.00 | 40.00 |
| Maltitol Syrup | 19.99 | 199.90 | 19.99 | 199.90 |
| Brown Rice Syrup | 10.00 | 100.00 | 10.00 | 100.00 |
| Sucralose | 0.03 | 0.30 | 0.03 | 0.30 |
| Dark Chocolate | 18.98 | 189.80 | 18.98 | 189.80 |
| Coating | | | | |
| Total | 100.00 | 1000.00 | 100.00 | 1000.00 |

### Example 10

### Chocolate Coated Peanut Butter Sheet and Cut Type Bars

The following example relates to a method of making a sheet and cut type bar that contains an amount of SDA enriched soybean oil.

Table 16 below provides detailed amounts of the ingredients.

All of the liquid ingredients and the peanut butter, with the exception of the oil, were combined and heated in the microwave for approximately 30 seconds to ease blending. The liquid ingredients, including the oil, were then placed in a Kitchenaid™ mixer and mixed for 1 minute using the flat beater attachment, at speed 3.

All of the dry ingredients were combined in a separate container and mixed by hand until well blended. The dry ingredients were then added to the liquid ingredients in the Kitchenaid™ mixer and mixed for 1 minute, at speed 2, to initially blend after which the speed was increased to speed 4 for an additional 3 minutes.

The resulting mixture was placed on a flat surface and formed into a rectangle. It was then rolled out to approximately 19 mm (¾ inch) thickness before being cut into 50 g servings using a dough cutter.

The chocolate compound was heated in the microwave for approximately 90 seconds to melt it before coating the bars. The bars were allowed to rest for 15 minutes after being coated with the chocolate compound before they were packaged.

This chocolate coated peanut butter sheet and cut formulation will deliver approximately 375 mg SDA per 50 g serving size of chocolate bar against the target of 375 mg SDA per serving.

TABLE 16
Chocolate Coated Peanut Butter Cut and Sheet Bar

| | Control | | | |
|---|---|---|---|---|
| | Soybean | | | |
| | Oil | | SDA Oil | |
| Ingredients: | (%) | (g) | (%) | (g) |
| Corn Syrup | 17.64 | 176.40 | 17.64 | 176.40 |
| Glycerin | 2.73 | 27.30 | 2.73 | 27.30 |
| Liquid Fructose | 2.95 | 29.50 | 2.95 | 29.50 |
| Arabic Gum | 2.48 | 24.80 | 2.48 | 24.80 |
| Vanilla Flavor | 0.25 | 2.50 | 0.25 | 2.50 |
| Creamy Peanut Butter | 2.97 | 29.70 | 2.97 | 29.70 |
| Soybean oil | 4.00 | 40.00 | 0.00 | 0.00 |
| SDA oil | 0.00 | 0.00 | 4.00 | 40.00 |
| Soy Protein Isolate | 3.32 | 33.20 | 3.32 | 33.20 |
| Fructose | 5.88 | 58.80 | 5.88 | 58.80 |
| Peanut Flour | 3.47 | 34.70 | 3.47 | 34.70 |
| Roasted, Unsalted | 4.40 | 44.00 | 4.40 | 44.00 |
| Peanuts | | | | |
| Soy Nugget | 31.35 | 313.50 | 31.35 | 313.50 |
| Milk Chocolate Coating | 18.46 | 184.60 | 18.46 | 184.60 |
| Compound | | | | |
| Salt | 0.10 | 1.00 | 0.10 | 1.00 |
| Total | 100.00 | 1000.00 | 100.00 | 1000.00 |

### Example 11

### Baked Granola Bar

TABLE 17

| | |
|---|---|
| | SDA |
| | enriched |
| Soybean | soybean |
| oil | oil |

| Ingredients: | g | % | g | % |
|---|---|---|---|---|
| Rolled oats | 240.7 | 28.6 | 240.7 | 28.6 |
| Raw sunflower seeds | 42.5 | 5.0 | 42.5 | 5.0 |
| Sliced almonds | 68.2 | 8.1 | 68.2 | 8.1 |
| Wheat germ | 42.5 | 5.0 | 42.5 | 5.0 |
| Honey | 170.1 | 20.2 | 170.1 | 20.2 |
| Brown sugar | 49.6 | 5.9 | 49.6 | 5.9 |
| Unsalted butter | 4.3 | 0.5 | 4.3 | 0.5 |
| Soybean oil | 42.9 | 5.1 | 0.0 | 0.0 |
| SDA enriched soybean oil | 0.0 | 0.0 | 42.9 | 5.1 |
| Vanilla extract | 10.0 | 1.2 | 10.0 | 1.2 |
| Salt | 2.5 | 0.3 | 2.5 | 0.3 |
| Chopped dried fruits | 168.3 | 20.0 | 168.3 | 20.0 |
| Totals: | 841.6 | 100.0 | 841.6 | 100.0 |

A. Butter is spread onto 9 by 9-inch glass baking dish, and pan is set aside;
B. The oats, sunflower seeds, almonds, and wheat germ are spread onto a half-sheet pan (oat mixture), and toasted in the oven (177° C.) for 15 minutes, stirring occasionally;
C. Meanwhile, the honey, brown sugar, butter, oil, vanilla extract and salt are combined in a medium saucepan, and heated at medium heat until the brown sugar is completely dissolved;
D. Once the oat mixture is baked, the pan is removed from the oven, and oven temperature is decreased to 149° C.;
E. The oat mixture is added to the liquid mixture immediately, and the chopped dried fruits are added, and the mixture is stirred until combined;
F. The mixture is turned out onto the prepared baking dish, and pressed down to distribute the mixture evenly in the baking dish,
G. The pressed mixture is baked at 149° C. for 25 minutes;
H. After cooling, the pressed mixture is cut into squares, and packaged.

While the invention has been explained in relation to exemplary embodiments, it is to be understood that various modifications thereof will become apparent to those skilled in the art upon reading the description. Therefore, it is to be understood that the invention disclosed herein is intended to cover such modifications as fall within the scope of the appended claims.

1. A food composition having an amount of omega-3 fatty acids, wherein the composition comprises:
a. an amount of a SDA enriched soybean oil; and,
b. a stabilizing agent.

2. The food composition of claim 1 selected from the group consisting of a baked food composition, a bar composition, and combinations thereof.

3. The composition of claim 1, wherein the composition includes a protein selected from the group consisting of soy protein, pea protein, milk protein, and combinations thereof.

4. The composition of claim 2, wherein the food composition is selected from the group consisting of breakfast cereals, breads, baked products, cakes, pies, rolls, cookies, crackers, tortillas, doughs, granola bars, nutrition bars, energy bars, sheet and cut bars, extruded bars, baked bars, and combinations thereof.

5. The composition of claim 1, wherein the SDA enriched soybean oil is selected from the group consisting of SDA enriched soybean oil, SDA enriched soy flour, and combinations thereof.

6. The composition of claim 1, wherein the stabilizing agent is a phospholipid or combination of phospholipids.

7. The composition of claim 1, wherein the stabilizing agent is selected from the group consisting of lecithin, phosphatidylcholine, phosphatidylethanolamine, phosphatidylinositol, phosphatidylserine, diphosphatidylglycerol, dipalmitoylphosphatidylcholine, 1-stearyoyl-2-myristoylphosphatidylcholine, or 1-palmitoyl-2-linoleoylethanolamine, and mixtures thereof.

8. The composition of claim 1, wherein the stabilizing agent ranges between about 0.1% to about 65% by weight of the SDA enriched soybean oil.

9. The composition of claim 1, wherein the composition comprises a secondary antioxidant selected from the group consisting of ascorbic acid and its salts, ascorbyl palmitate, ascorbyl stearate, anoxomer, N-acetylcysteine, benzyl isothiocyanate, o-, m- or p-amino benzoic acid (o is anthranilic acid, p is PABA), butylated hydroxyanisole (BHA), butylated hydroxytoluene (BHT), caffeic acid, canthaxantin, alpha-carotene, beta-carotene, beta-carotene, beta-apo-carotenoic acid, carnosol, carvacrol, cetyl gallate, chlorogenic acid, citric acid and its salts, clove extract, coffee bean extract, p-coumaric acid, 3,4-dihydroxybenzoic acid, N,N′-diphenyl-p-phenylenediamine (DPPD), dilauryl thiodipropionate, distearyl thiodipropionate, 2,6-di-tert-butylphenol, dodecyl gallate, edetic acid, ellagic acid, erythorbic acid, sodium erythorbate, esculetin, esculin, 6-ethoxy-1,2-dihydro-2,2,4-trimethylquinoline, ethyl gallate, ethyl maltol, ethylenediaminetetraacetic acid (EDTA), eucalyptus extract, eugenol, ferulic acid, flavonoids (e.g., catechin, epicatechin, epicatechin gallate, epigallocatechin (EGC), epigallocatechin gallate (EGCG), polyphenol epigallocatechin-3-gallate), flavones (e.g., apigenin, chrysin, luteolin), flavonols (e.g., datiscetin, myricetin, daemfero), flavanones, fraxetin, fumaric acid, gallic acid, gentian extract, gluconic acid, glycine, gum guaiacum, hesperetin, alpha-hydroxybenzyl phosphinic acid, hydroxycinammic acid, hydroxyglutaric acid, hydroquinone, N-hydroxysuccinic acid, hydroxytryrosol, hydroxyurea, lactic acid and its salts, lecithin, lecithin citrate; R-alpha-lipoic acid, lutein, lycopene, malic acid, maltol, 5-methoxy tryptamine, methyl gallate, monoglyceride citrate; monoisopropyl citrate; morin, beta-naphthoflavone, nordihydroguaiaretic acid (NDGA), octyl gallate, oxalic acid, palmityl citrate, phenothiazine, phosphatidylcholine, phosphoric acid, phosphates, phytic acid, phytylubichromel, pimento extract, propyl gallate, polyphosphates, quercetin, trans-resveratrol, rice bran extract, rosemary extract, rosmarinic acid, sage extract, sesamol, silymarin, sinapic acid, succinic acid, stearyl citrate, syringic acid, tartaric acid, thymol, tocopherols (i.e., alpha-, beta-, gamma- and delta-tocopherol), tocotrienols (i.e., alpha-, beta-, gamma- and delta-tocotrienols), tyrosol, vanilic acid, 2,6-di-tert-butyl-4-hydroxymethylphenol (i.e., lonox 100), 2,4-(tris-3′,5′-bi-tert-butyl-4′-hydroxybenzyl)-mesitylene (i.e., lonox 330), 2,4,5-trihydroxybutyrophenone, ubiquinone, tertiary butyl hydroquinone (TBHQ), thiodipropionic acid, trihydroxy butyrophenone, tryptamine, tyramine, uric acid, vitamin K and derivates, vitamin Q10, wheat germ oil, zeaxanthin, or combinations thereof.

10. The composition of claim 1, wherein the composition comprises a secondary antioxidant selected from the group consisting of tocopherols, ascorbyl palmitate, ascorbic acid, rosemary extract, and combinations thereof.

11. The composition of claim 1, wherein the secondary antioxidant is added in an amount ranging between 0.001% and about 5% by weight of the SDA enriched soybean oil.

12. A method of using SDA enriched soybean oil to form a baked product, wherein the method comprises:
a. adding SDA enriched soybean oil to a dough; and,
b. baking the dough.

13. The method of claim 12 wherein the SDA enriched soybean oil comprises between 5% and 100% of fat required in the dough.

14. The method of claim 12 wherein the SDA enriched soybean oil and the stabilizing agent are mixed prior to adding to the dough.
